(19) United States
(12) Patent Application Publication
(10) Pub. No.: US 2015/0156183 A1
(43) Pub. Date: Jun. 4, 2015

(54) SYSTEM AND METHOD FOR FILTERING NETWORK COMMUNICATIONS

(71) Applicant: GateSecure S.A., Fentange (LU)

(72) Inventors: Sascha Beyer, Kempen (DE); Bertrand Gasnier, Luxembourg (LU); Bartosz Muszynski, Fentange (LU); Fabian Rami, Trintange (LU)

(73) Assignee: GateSecure S.A., Fentange (LU)

(21) Appl. No.: 14/095,387

(22) Filed: Dec. 3, 2013

(51) Int. Cl. H04L 29/06; H04L 12/58

(52) U.S. Cl. CPC H04L 63/08; H04L 51/04

(57) ABSTRACT

Embodiments of a secure network gateway system and a filtering method using the system are disclosed. The secure network gateway system includes a tunneling front end node capable of establishing a communication tunnel with a client access point and authenticating a user to allow the user to access to a wide area network via the communication tunnel. The system also includes a plurality of filter nodes. A plurality of filtering rules are associated with the authenticated user. The tunneling front end node is capable of determining how to handle transmissions to and from the authenticated user according to these filtering rules and passing the transmissions to the appropriate filter nodes. The filter nodes are capable of filtering transmissions according to the filtering rules and passing the filtered transmissions to the tunneling front end node for forwarding to the authenticated user via the communications tunnel.

### TECHNICAL FIELD

The embodiments described herein generally relate to network filtering systems and, in particular, Internet filtering systems

### BACKGROUND

Today, most children come into contact with the Internet when they've just learned to read. They use it actively, do research for homework and have their own computer or mobile device with direct access to the Internet. Parents often do not have the time to be behind the back of their children when they are online although they know well that the Internet can be a dangerous place to be: Viruses might be caught, pornography accessed, content causing fear consumed, fraudulent downloads made with all possible consequences and contacts with dishonest people established. Moreover, children have now less and less difficulties to find a way to disable the local Parental Control software and bypass it.

### SUMMARY

Embodiments of the systems and methods described herein does not mandate any software to install on local devices. Instead, the embodiments may be device independent and OS/browser independent. In such a manner, the “intelligence” may thus be moved from the local devices to the cloud, which makes the protection totally transparent, difficult to bypass and very efficient.

In general, family members are identified when connecting to the Internet from any device in the household and are then protected according to the configuration made by the parents on the configuration website. Depending on the Internet traffic type, several high-speed filters are called to analyze the content in real time and decide to let the traffic going through or warn/block the content.

Embodiments of a secure network gateway system and a filtering method using the system are disclosed. The secure network gateway system includes a tunneling front end node capable of establishing a communication tunnel with a client access point where packets transmitted through the communication tunnel are encapsulated. The tunneling front end node is also capable of authenticating a user of a user device in communication with the client access point so that the user may be allowed access to a wide area network (such as the Internet) via the communication tunnel after successful authentication.

The system also includes a plurality of filter nodes in communication with a network interface so that the filter nodes are connected to the wide area network via the network interface. A plurality of filtering rules are associated with the authenticated user that define how transmissions between the user and wide area network are to be handled. The tunneling front end node is capable of determining how to handle transmissions to and from the authenticated user according to these filtering rules and passing the transmissions to the appropriate filter nodes. The filter nodes are also capable of sending and receiving the transmissions between the authenticated user and the wide area network according to the criteria defined by the filtering rules. With respect to inbound transmissions from the wide area network, the filter nodes also are capable of filtering these transmissions according to the filtering rules and passing the filtered transmissions to the tunneling front end node for forwarding to the authenticated user via the communications tunnel.

The system may further include worker and job dispatcher nodes. The worker node may be capable of receiving messages containing status information from the nodes. Based on these messages, the worker node may generate jobs that it may then send to the job dispatcher node. The job dispatcher node is capable of assigning the received jobs to the appropriate nodes and sending messages to those nodes instructing them to perform the assigned job.

In some embodiments, the communication tunnel between the tunneling end node and client access point may be an OpenVPN tunnel, a PPTP tunnel, or a LISP tunnel. Further embodiments may be implemented where a tunneling identifier associated with the user may be included in subsequent communications between the user device and the tunneling front end node after the user has been successfully authenticated. In some implementations, an internal communications network may be provided in the system through which the nodes can send communications between one another.

The job dispatcher may be capable of scheduling jobs based on the type of job and the location of the target node. These jobs may include parallel-type jobs and sequential-type jobs. With respect to parallel-type jobs, the job dispatching node may be capable of sending the message for a pending parallel-type job to the assigned node as soon as the assigned node indicates no other job with a status of processing is currently assigned to that node. On the other hand, with respect to sequential-type jobs, the job dispatching node may be capable of sending the message for a pending sequential-type job to the assigned node when the assigned node has only one job with a status of processing. In certain implementations, the messages sent by the worker node and the job dispatcher node may comprise SOAP messages.

The filter nodes may include a number of different types of filter nodes including one or more web filters nodes that are capable of receiving HTTP and other Internet-format packets. Another type of filter node that may be included is one or more mail filter nodes that are capable of receiving packets conforming to at least one electronic mail message format. A further type of filter node may be one or more instant message filters that capable of receiving instant messaging format packets. In addition, embodiments may be implemented where the filter nodes include one or more game filter nodes capable of filtering online game content and/or one or more file/media filter nodes capable of filtering at least one of content, streaming content, downloadable content, image content, and video content. One or more storage nodes may also be provided that are capable of temporarily storing data downloaded from the wide area network. Such storage nodes may include a scanning element that is capable of scanning the downloaded data according to the filtering rules to identify portions of the data that are to be blocked from delivery to the authenticated user.

The filtering rules may include rules for blocking certain transmissions between the authenticated user and wide area network, rules for allowing certain transmissions between the authenticated user and the wide area network, and rules for filtering content of transmissions received from the wide area network that are intended for the authenticated user. In one embodiment, the filtering rules may include filtering rule(s) selected by a registered user.

Embodiments may be implemented to include a firewall node capable of maintaining the filtering rules associated with authenticated user in an IP table. In such an embodiment, the IP table may be created after the user has been authenticated and may be torn down after the user has logged out.

In some embodiments, the time that the authenticated user may be limited. For example, embodiments may be implemented where the user may be automatically logged out after a predetermined amount of time has elapsed after authentication. As another example, the user may be automatically logged out after a predetermined amount of time of inactivity or lack of use of the system by the authenticated user has elapsed. As another example, a user may be restricted access to the Internet at certain times in the date. For instance, a parent may set criteria to allow a child access to the Internet (via the system) only between 6:00 p.m. and 9:00 p.m. and thereby restrict/prevent the child from accessing the Internet the rest of the day (i.e., between 9:01 pm until to 5:59 pm). In other words, inside the allowed period, the child may be permitted to login while outside the allowed period, the child will not be permitted to login.

Using the secure network gateway system, various embodiments of a method for filtering communication may be accomplished. In such methods, a communication tunnel between a tunneling front end node and a client access point may be established where packets transmitted through the communication tunnel are encapsulated. The tunneling front end node may authenticate a user of a user device in communication with the client access point whereby the user is allowed to access to the wide area network after a successful authentication through the communication tunnel. The tunneling front end node may also determine how to handle transmissions to and from the authenticated user according to a plurality of filtering rules associated with the authenticated user. Accordingly, at least some of the transmissions received from the user of the user device may be passed to at least one of a plurality of filter nodes according to the filtering rules. The filter nodes may send transmissions of the authenticated user to the wide area according to the filtering rules associated with the authenticated user as well as receive transmissions from the wide area network destined to the authenticated user. The filter nodes may also filter the transmissions received from the wide area network according to the filtering rules associated with the authenticated user and forward the transmissions to the authenticated user via the communications tunnel.

Further methods may be implemented where a worker node may receive one or more messages from one or more of nodes with the messages containing information concerning activity or status of the one or more nodes. The worker node may then generate one or more jobs in response to a received message and sending each generated job to a job dispatcher node. When the job dispatcher node receives the generated jobs sent by the worker node, the job dispatcher node may assign the generated job to one of the nodes, and then send a message to the node instructing it to perform the assigned jobs. In some embodiments, the various messages may comprise SOAP messages.

As mentioned herein, embodiments may be implemented where the jobs include parallel-type jobs and sequential-type jobs. In such embodiments, the job dispatching may send the message for a pending parallel-type job to the assigned node as soon as the assigned node indicates no other job with a status of processing is currently assigned to that node. In addition, the job dispatching node may send the message for a pending sequential-type job to the assigned node when the assigned node has only one job with a status of processing.

### BRIEF DESCRIPTION OF THE DRAWINGS

FIG. 1 is a block diagram of an exemplary secure network gateway system in which embodiments described herein may be implemented.

FIG. 2 is an exemplary embodiment of the system implemented using a LISP architecture.

FIG. 3 is a schematic diagram of an exemplary embodiment of a client access point.

FIG. 4 depicts another implementation of the client-side box.

FIG. 5 is a schematic diagram of an exemplary architective for a Virtual Live System implementation of the filtering system.

FIG. 6 is an exemplary Job table in accordance with one embodiment of the Job Dispatcher.

FIG. 7 is a hierarchical diagram for an exemplary set of Job classes.

FIG. 8 is a relationship diagram showing exemplary tables that correspond to the network's entities.

FIG. 9 is a relation diagram showing exemplary relationships between Node, HardwareComponent and Location.

FIG. 10 is an exemplary block diagram of a TaskletMngr class executing tasklets.

FIG. 11 depicts an exemplary site-reap of a website of the web server.

FIG. 12 is a flowchart of an exemplary set of checks carried out by the system when a user access the system.

FIG. 13 is a block diagram showing the Firewall Node's interactions with other components of the system.

FIG. 14 is a sequence diagram for implementing a protocol message procedure. The Protocol message is a bunch of rules that is translated into iptables commands by FirewallServer.

FIG. 15 is a sequence diagram for implementing a protocol with timerestiction message procedure.

FIG. 16 is a sequence diagram for implementing a teardown message procedure.

FIG. 17 is a diagram of a login decision process in accordance with one embodiment.

FIG. 18 is a diagram of a logout decision process in accordance with one embodiment.

FIG. 19 is a schematic diagram of an exemplary web filter.

FIG. 20 is a flowchart of routing cases of an exemplary HA-Proxy.

FIG. 21 is a flowchart of an exemplary decision making process for a HA-Proxy.

FIG. 22 is a flowchart for selecting a storage server.

FIG. 23 is a flowchart for an exemplary process for filtering incoming requests.

FIGS. 24a and 24b illustrate an exemplary flowchart illustrating a process that a Web Filter may use in determining which filters to apply.

FIG. 25 is a flowchart of a process for processing downloadable content using a downloadable service node/module.

FIG. 26 is a block diagram of an exemplary downloadable service node/module capable of carrying out the process depicted in FIG. 25.

FIG. 27 is a flowchart of a process for extracting and scanning contents using the monitor thread and Avia thread.

FIG. 28 shows connection daemon functional diagram for the game filter node.

FIG. 29 is a diagram of a network topology for filtering email by the filtering system.

FIG. 30 is an application stack diagram illustrating various components of the Mail Proxy.

FIG. 31 is a workflow diagram for a MailProxy. MailProxy defines basic service to implement.

FIG. 32 is a block diagram of an exemplary architecture for a Mail Filter of a Mail Filter node.

FIG. 33 is a schematic diagram illustrating various relationships between the components of the Mail Filter depicted in FIG. 32.

FIG. 34 is a sequence diagram illustrating a process for the Mail Filter to accept a new connection.

FIG. 35 is a sequence diagram illustrating how the Mail Filter handles a client request.

FIG. 36 is a class diagram of an exemplary Configuration Manager of the Mail Filter.

FIG. 37 is a class diagram of an exemplary DB Manager of the Mail Filter.

FIG. 38 is a class diagram of the Request/Response Handler.

FIG. 39 is a class diagram of the Mail Filter class.

FIG. 40 is a block diagram of an exemplary architecture for an IM Filter.

FIG. 41 is a flowchart of IM Filter process threads.

### DETAILED DESCRIPTION

### General Architecture:

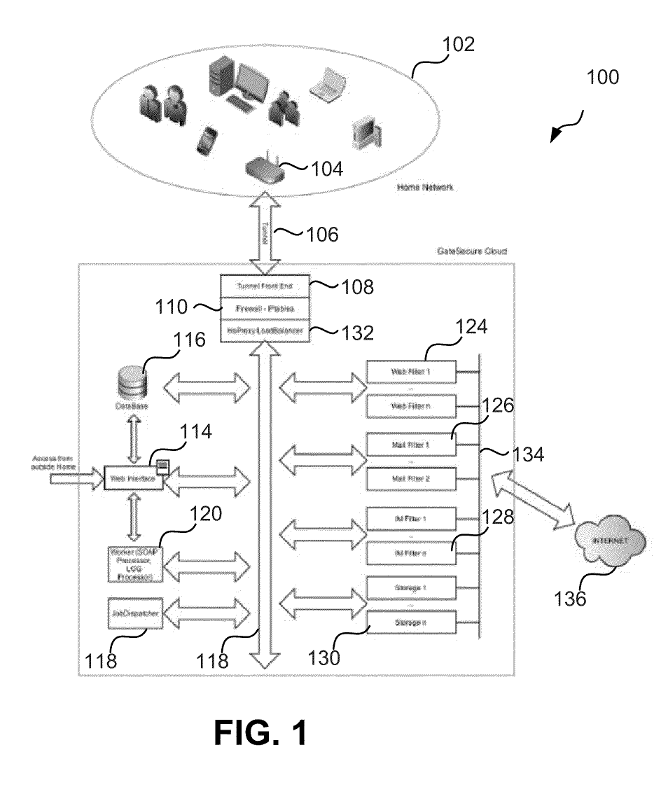

FIG. 1 is a block diagram of an exemplary secure network gateway system 100 in which embodiments described herein may be implemented. The secure network gateways system 100 may also be referred to herein as the GateSecure Cloud System 100.

Home network 102: All the Internet traffic from the Household may be redirected to the GateSecure Cloud System 100. This may be done by establishing a tunnel connection between the two sides—the system 100 and a remote client access point 104—either directly from a router adapted for communications with the system 100 (such routing devices may be referenced herein as a “box”, GateSecure box, AVM FRITZ!Box, or mailbox v2) or by adding an additional device (which may be also referred to herein as certain implementations of the GateSecure box) coupled to the router that is adapted for affording communications with the system 100. It may also be possible to install a tunnel client software on one single device to protect (e.g., as described herein for certain implementation using OpenVPN client software).

Tunnel Server 106: Once the Tunnel Front End 108 has authenticated the client (e.g., device 104) and accepted the connection (meaning that a customer has registered to the service before and a Tunnel Id with credentials have been assigned to that customer's account), it may start to receive all the Internet traffic from this household and redirects the various traffic flows to the correct modules of the system 100 depending on their types (e.g., HTTP, HTTPS, SMTP) by passing through a Firewall 110. The server 106 is the entrypoint to the filtering services of the system and the tunnel is the component with the interface where the clients (routers, Fritzboxes, cellphones, computers, maxboxes) can connect to. The server 106 is also the exitpoint of an established tunnel connection where the traffic will be redirected to the different components in cloud 100.

In general, each individual user of any device (e.g., user device 112) connected to the access point 104 has to authenticate on a login page that may be displayed by Web Interface 114 (with the user's credentials stored in the DataBase 116), and is then identified uniquely in the system 100 until he logs out. All the packets coming from this user may be analyzed according to the settings defined in the DataBase 116 for that user/customer account.

The system 100 may include an internal communication network 118 or bus that couples some or all of the components of the system 100 to one other. Within the System 100, communications between the different parts may be handled by two nodes: the Worker 120 and the JobDispatcher 122 (also referred to as the Management node). The Worker 120 is in charge of receiving SOAP messages from the various filters of the system or from the Web Interface and converting them into jobs for the other parts. The JobDispatcher/Management node 122 is in charge of dispatching the jobs between the parts of the system. For example, when a user logs in the Web Interface 114 (e.g., at his connection to the Internet from a device at Home), a SOAP message may be sent to the Worker 120 which converts it into multiple protocol jobs for settings some defined routing rules in the Firewall 110, enabling or disabling some desired filters, and so on.

The system also includes a plurality of filter and storage nodes 124, 126, 128, 130. As mentioned above, each packet sent from the user via the access point 104 may be identified by the Tunnel Front End node 108 according to its type and redirected to the correct filter. For example, HTTP packets may be redirected to a Web Filter 124, whereas SMTP packets may be redirected to a Mail Filter 126, instant message packets may be redirected to an instant message (IM) filter 128. As shown in FIG. 1, there may be one or more instances of each type of filter node 124, 126, 128, 130.

In addition, all the filters 124, 126, 128, 130 may receive the packets with a user Identification inserted in the HEADER by HaProxy node 132. This allows the filters (and other nodes in the system) to identify the filtering settings for this particular user (i.e., the user who is sending or receiving the packets) and perform the correct filtering actions depending on the packets content. For example, if a user is set to be protected against pornographic content and the packet is a GET on an URL known to contain pornographic images, then the Web Filter 124 may block the request and instruct the Web Server to display a blocking page instead of the requested pornographic web site.

Generally speaking, all the filters act as proxies meaning that they are positioned in between the clients and the servers on Internet. Harmless contents may be left alone without touching them in up and down. However, harmful contents can be blocked or modified (e.g., in case of “bad” words which can be replaced by “***” or other indicia in an email or a web page) and/or requests can be redirect to a specific page for user notification.

The Storage nodes/servers 130 may be used to temporarily download files and scan them against viruses, for example. While it may depend on the particular implementation, zipped or compressed files may need to be decompressed before checking if they contain pornographic images as well.

The system 100 may also include a network interface 134 through which the system 100 may access the Internet 136 or other wide area network. The filters 124, 126, 128, 130, for example, may communicate with the Internet 136 through this network interface 134.

With this overview, the various components of the system 100 will be described in further detail.

Client/Server Tunneling 106: A prerequisite for filtering the Internet traffic of an household or an office is the access to the data. GateSecure 100 provides in-stream filtering which means that the Internet stream may be forwarded to GateSecure servers 100 from the client side 104. GateSecure servers expect to receive this stream through a Client-Server Tunneling 106 on several different types and protocols. Different types of tunneling can be used including OpenVPN, PPTP and LISP.

An OpenVPN tunnel may be carried out using RPM packages for a tunnel: tunnel_hostconf_openvpn (OpenVPN server with a tun interface) and tunnel_hostconf_openvpn_tap (OpenVPN server with a tap interface). In computer networking, TUN and TAP are virtual-network kernel devices. As network devices supported entirely in software, they differ from ordinary network devices that are backed up by hardware network adapters. TAP (as in network tap) simulates a link layer device and it operates with layer 2 packets such as Ethernet frames. TUN (as in network TUNnel) simulates a network layer device and it operates with layer 3 packets such as IP packets. TAP is used to create a network bridge, while TUN is used with routing. Packets sent by an operating system via a TUN/TAP device are delivered to a user-space program that attaches itself to the device. A user-space program may also pass packets into a TUN/TAP device. In this case TUN/TAP device delivers (or “injects”) these packets to the operating-system network stack thus emulating their reception from an external source. The tap interface tunnel has the advantage for the usage of ebtables bridging, this is what may be used on the access point box. The ebtables program is a filtering tool for a Linux-based bridging firewall. It enables transparent filtering of network traffic passing through a Linux bridge. The filtering possibilities are limited to link layer filtering and some basic filtering on higher network layers. Advanced logging, MAC DNAT/SNAT and brouter facilities are also included. The ebtables tool can be combined with the other Linux filtering tools (iptables, ip6tables and arptables) to make a bridging firewall that is also capable of filtering these higher network layers. This is enabled through the bridge-netfilter architecture which is a part of the standard Linux kernel.

A PPTP tunnel may be supported in the following RPM package for a tunnel: tunnel_hostconf. The Point-to-Point Tunneling Protocol (PPTP) is a method for implementing virtual private networks. PPTP uses a control channel over TCP and a GRE tunnel operating to encapsulate PPP packets. The PPTP specification does not describe encryption or authentication features and relies on the Point-to-Point Protocol being tunneled to implement security functionality. However, the most common PPTP implementation shipping with the Microsoft Windows product families implements various levels of authentication and encryption natively as standard features of the Windows PPTP stack. The intended use of this protocol is to provide security levels and remote access levels comparable with typical VPN products.

A LISP tunnel may be supported in the following RPM package for a tunnel: tunnel_hostconf_lisp. In certain implementations, LISP tunneling may require hardware or virtualized router that is with enabled LISP functionality. Currently, certain CISCO routers have this type of functionality. This LISP tunnel will preprocess the traffic for a usable traffic format for our tunnel that is configured by the RPM package tunnel_hostconf_lisp. Locator/Identifier Separation Protocol (LISP) is a “map-and-encapsulate” protocol which is developed by the Internet Engineering Task Force LISP Working Group. The basic idea behind the separation is that the Internet architecture combines two functions, routing locators (where a client is attached to the network) and identifiers (who the client is) in one number space: the IP address. LISP supports the separation of the IPv4 and IPv6 address space following a network-based map-and-encapsulate scheme (RFC 1955). In LISP, both identifiers and locators can be IP addresses or arbitrary elements like a set of GPS coordinates or a MAC address.

Client Side Connection/Access Point 104: In order to access to the filtering service from a customer household or from our offices, one of the above described tunneling methods may be used for a connection that has to be established between the client and the server. This can be done by various types of hardware or software including stand alone client software or Routers (e.g., DSL routers and the like). Some exemplary implementations may include an AVM Fritzbox with maxstick (USB-stick with OpenVPN as connection method), an AVM Fritzbox with maxgate-image (customized pseudo firmware that adds functionality to establish an OpenVPN connection to our services without any extra hardware); an AVM Fritzbox with LISP; a Netgear router with maxgate-image; a maxbox v1 or v2 with OpenVPN or a maxbox v2 with LISPmob.

Generally all the clients connect to the tunnel endpoint 108 where the filtering starts. The traffic will be redirected by the firewall 110 to the locally running load balance proxy HAProxy 132, which will decide to which filter will be forwarded the requests. In one embodiment, the HAProxy 132 may be an open source TCP/HTTP load balancer, used to improve the performance of web sites and services by spreading requests across multiple servers. Its name stands for High Availability Proxy. It is written in C and has a reputation for being fast, efficient (in terms of processor and memory usage) and stable. On the tunnel, HA-Proxy is used to complete the following goals: Insert custom headers into html request in order to link internally the traffic to a device, and Load balance supported traffic to the filtering nodes (i.e., traffic supported by the various implemented filters).

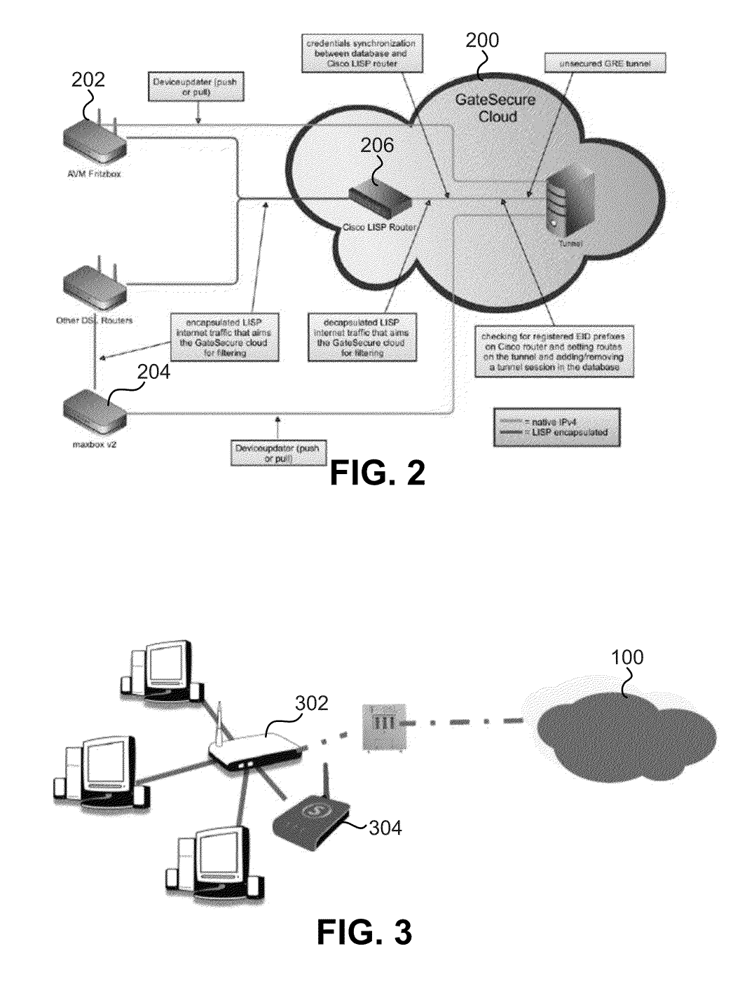

FIG. 2 is an exemplary embodiment of the system 200 implemented using a LISP architecture. In this exemplary LISP implementation on the AVM Fritzbox 202 or maxbox v2 204 (with LISPmob), the system 200 gets all native IPv4 request traffic encapsulated in LISP and are forward to a Cisco LISP router 206. On the other side, all response traffic will be also encapsulated in LISP packets by the Cisco LISP router and send back to the AVM Fritzbox or maxbox v2. The Cisco LISP router decapsulates all request traffic from the AVM Fritzbox or maxbox v2 that aims the filters. The tunnel sends already native IPv4 response traffic to the Cisco LISP router. The connection between the Cisco LISP router and the tunnel may be implemented by an unsecured GRE tunnel. All LISP nodes may register at the Map Server on the Cisco LISP router.

For registering LISP nodes at the MapServer on the Cisco LISP router, LISP sites may need to be configured on the Cisco router. The configuration containing the credentials and networks is fetched from the database and transformed for the Cisco routers LISP MapServer. For this process a cronjob may be used that calls the script /usr/local/sbin/cisco_lisp_user_sync.php periodically. When a LISP node registered at the MapServer on the Cisco LISP router, an appropriate route on the tunnel may then be set, so that traffic correctly can be correctly routed to and from the LISP node. Beside this, a tunnel session may be set up in the database for this node. For this process a daemon /etc/init.d/lispconnector may be used which uses a script /usr/local/sbin/lisp_connector. To populate our clouds device list, a device updater may be used. This can either pull information about all devices behind a LISP node (e.g. DHCP lease table) or this information can be pushed by the LISP node to our tunnel or webserver (device. api.gatesecure.com). Every MAC and IP address and hostname of a local device may need to be obtained. This process can be defined by the standard tr064 or by a custom solution.

LISPmob may be used as a LISP implementation to route traffic to the tunnel. A LISPmob typically has to run on a device with a public internet IP. LISPmob is an open-source LISP and LISP Mobile Node implementation for Linux, Android and OpenWRT. Sources for LISPmob can be download from http://lispmob.org. With LISPmob, hosts can change their network attachment point without losing connectivity, while maintaining the same IP address.

FIG. 3 is a schematic diagram of an exemplary embodiment of a client access point 104 comprising a router 302 coupled to a device 304 (referred to herein as a box, maxbox or GateSecure box) adapted to establishing the tunnel 106 with the tunneling front end 108 of the filtering system 100. Once the box 304 is installed in the client local network shown in FIG. 3, it may establish the Tunnel connection 106 with the Tunnel Front End node 108. As shown in FIG. 3, the box 304 is connected to the router 203 like any other local device (e.g., to a LAN port). The original Router may remain untouched and is still used to establish the broadband connection to the Internet (e.g., Cable or DSL). Depending on the implementation, user devices may connect to the Router via WiFi or other wireless link or may be hardwired connected to the router.

The box 304 may have multiple roles including, for example: (1) establish a link between the customer network and the system; (2) redirect traffic that needs to be filtered to the system; (3) detect the devices from the customer network, identify, them and update the information in the system; (4) display to the customer the current status of the protection provided by the system; (5) allow the user to manage his internal network; and (6) guide user through installation steps.

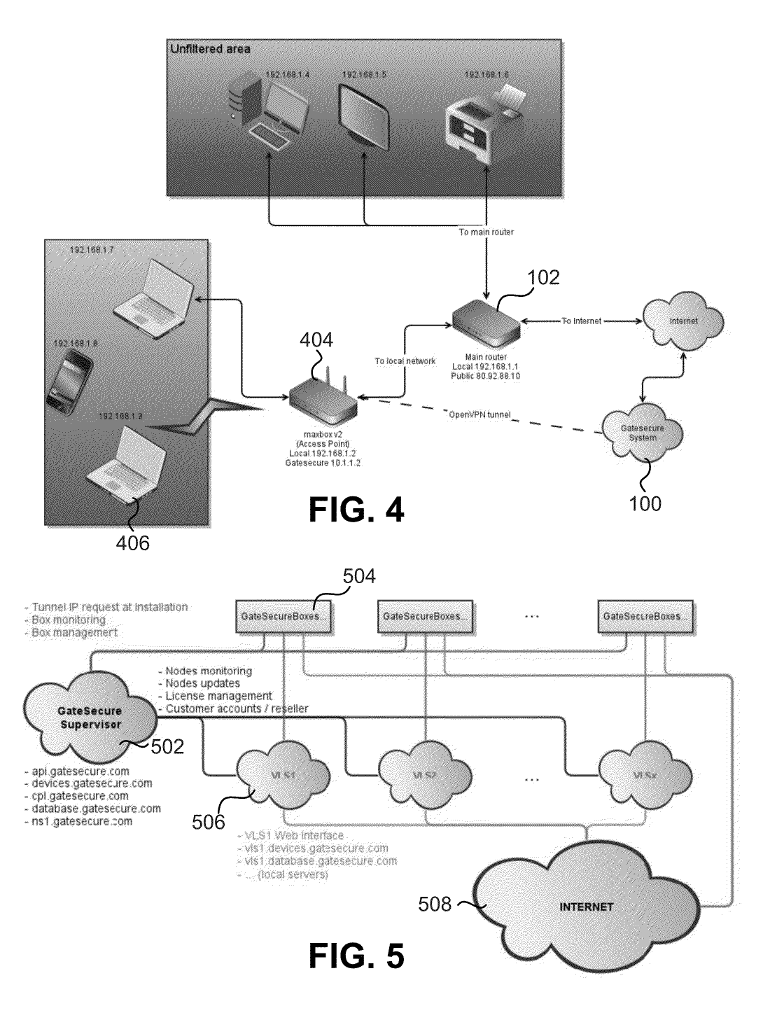

FIG. 4 depicts another implementation of the box (also referred to herein as maxbox v2) that may be used in embodiments of the system 100. In this embodiment, the box 404 and all the devices connected to it, get an IP from the main DSL router 402. Then requests on external IP (Public webpage or any Internet service) are redirected to the GateSecure Cloud System 100 and requests on internal IP (e.g., Printer or other device) are redirected to the Main DSL Router. In this embodiment, a bridge is used between the system 100 and the DSL network. This box may be able to detect from which network (filtered—not filtered) a device is making traffic, and then, alert parent if a supposed filtering device is on the wrong network.

In some implementations, the box 404 should get an IP in the range of the main router 402 and user devices 406 connected to the box 404 should also get an IP from the main router 402. The devices 406 connected to the box 404 should be redirected to the system 100 when requesting an external IP (e.g., Public webpage or any Internet service). They should be redirected to the Main router when requesting an internal IP (e.g., Printer or other device for example).

In this implementation, the box 404 has the ability to be transparent and act as its own Access Point. All the network workflows are still able to reach internal network devices (printer, storage server, Router DHCP . . . ) and the traffic to Internet is then redirected to the filtering system as needed. To redirect the traffic, EBTABLES may be used to watch on Layer 2 (OSI) and mark packets that need to be redirected and discard the traffic from the bridge. In order to detect devices inside the secure network, a copy of each dhcp packet may be made with Ebtables and stored in a queue for analysis. A dhcp analyser run on the box to explode the DHCP packet. This program fetch the hostname, mac address and ip fields if set. Those data are stored in UCI variable. In addition, if it is detected that the device is inside the filtered network (or if the device is from the main DSL router). Each time a new device is detected or change his parameters, the data may be pushed to the database through php scripts.

### Nodes and WWDM:

The secure network gateway system 100 is intended to be scalable and adaptable to multiple environments depending on where it is hosted. It can be hosted either on Dedicated Servers (also referred to herein as a Live System) or in Cloud Hosting Centers (also referred to herein as a Virtual Live System). In general, the components of the system 100 may be differentiated between filter nodes and WWDM (Webserver/Worker/Database/Management) nodes 114, 116, 120, 122.

Filternodes (e.g., Nodes 124, 126, 128, 130):

In the Live System and Test System, each filter node may be running on its own physical server or share servers one or more nodes on the same server). In one implementation, a bootstraped Gentoo host system may be used to run a OpenVZ kernel which runs the according filter node. This Gentoo host system may be selfconfigured via PXE on every reboot. The PXE process may be part of the WWDM Management node.

On the VLS and VTS they are running on one and the same physical server and share their resources. Compared to the Live System and Test System, the VLS and VTS don't use PXE to configure their nodes on a restart. They use preconfigured templates on the host system for configuration, that will be deployed into a OpenVZ container.

Tunnel Node 108: As previously mentioned, the general purpose of the tunnel node 108 is to have an entrypoint to our filtering cloud. All endpoint devices will connect somehow to this tunnel and redirect all their traffic into our tunnel. The tunnel server/client may also guarantee that the network of the clients is mapped accordingly to our customers reserved filtering network. For this, some mapping such as NAT can be used. The tunnel node may provide one (or more) of the following services: OpenVPN, PPTP, and lisp_connector+cisco_lisp_user_sync and following services on all of them: httpd for receiving SOAP messages from job dispatcher 122, FirewallServer 110, haproxy 132

Web Filters 124:

The general purpose of the web filter nodes 124 is to filter all http traffic, which also can include some kind of streaming like Streamcast/Icecast, Youtube, Vimeo, etc. These streaming websites typically stream over http (port 80) and may need to be processed by the webfilter. The webfilter makes a decision if it allows the customer to see a requested website, show a warning or to block a website. After a successful decision the traffic may be redirected out to the internet from there or redirected to the webserver in the case of a block or warning. The webfilter node 124 may provide the following services: httpd for receiving SOAP messages from job dispatcher, haproxy, Squid+C-ICAP module, Nginx, and urlserver

Mail Filters 126: The general purpose of the Mail Filter nodes 126 is to process all kind of email traffic (SMTP, POP3, SMTPS, POP3S, NAP, MAPS) and to block or mask emails containing security related content (phishing, spam, viruses, bad keywords, and bad contacts). The mailfilter nodes 126 may provide one or more of the following services: httpd for receiving SOAP messages from job dispatcher, mail_proxy for proxying the mail traffic to the real mail provider (e.g. Gmail), mailfilter as an interception module for the mail_proxy that processes and analyses the mail traffic and makes blocking or masking decisions.

Instant Message Filter (IM-Filter) Nodes 128:

The general purpose of the IM-Filter nodes 128 is to process all kind of chatting protocols (AIM, ICQ, MSN, . . . ) and to interact with the client and to block messages if necessary. The blocking decision is made on bad keywords or bad contacts.

### Manager/Job Dispatcher Node 122:

The management node 122 may provide one or more of the following services: PXE for transient nodes, DHCP service for transient nodes, Job dispatcher, SQUID for caching of repository data, Memcached for gaming data. Because of the relative importance of the management node 122, the system 100 may include more than one management node connected via heartbeat.

Virtual Live System (VLS) Implementation:

FIG. 5 is a schematic diagram of an exemplary architective for a Virtual Live System implementation of the filtering system 100. To deliver quickly the system 100, the system may be virtualized so that the system could be installed on a third party system or in preconfigured machines to connect to the correct tunnel. In such systems, the infrastructure may need to be datacenter independent with all nodes being hardware independent (i.e., Virtual Machines (VMs)). This allows the system to be scalable by adding more VM instances. As shown in FIG. 5, the VLS implementation may include a supervisor 502 coupled to one or more boxes 504 and VLS's 506 coupled to the Internet 508. The nodes of the system 100 may thereby be implemented on one or more of the VLS's. The supervisor 502 may be responsible for secure the access to the VLS's, keeping local repository up-to-date, monitoring the VLS's, managing the VM instances, keeping the local DNS updated, keeping data synchronized between Gatesecure DB and reseller DB. As an option, certain aspects/functionalities of the Worker and Management nodes may also be handled, for example, by the supervisor 502.

Job Dispatcher 122:

The Job Dispatcher 122 (also referred to herein as JobDispatcher) may be implemented as a C++ Linux application. Its primary responsibilities may include transforming the entries from the System.Job and System.JobAttribute DB tables in SOAP messages that are sent to other parts of the system infrastructure. As a secondary feature, the Job Dispatcher may also handle a number of jobs (e.g., Range, Host and Storage) that do not correspond to a SOAP message but, rather define either a direct action on the management machine or a change in the DB. JobDispatcher may be able to start as a daemon or as a console application. The JobDispatcher can also write log messages to file and/or to the console with different verbosity levels.

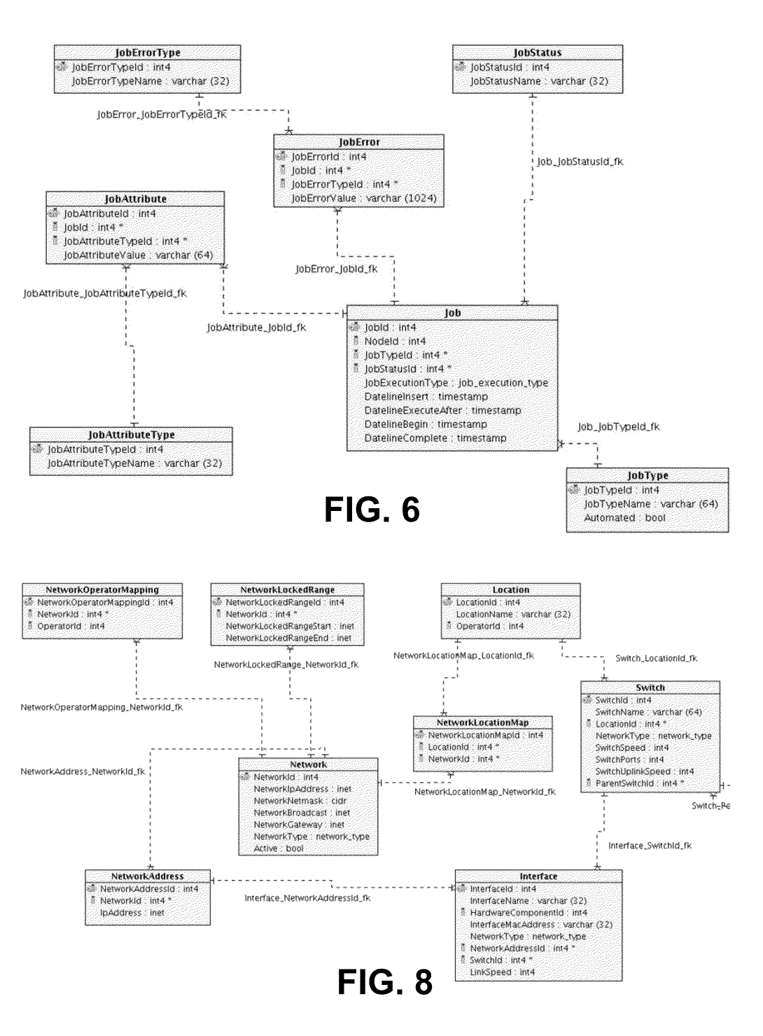

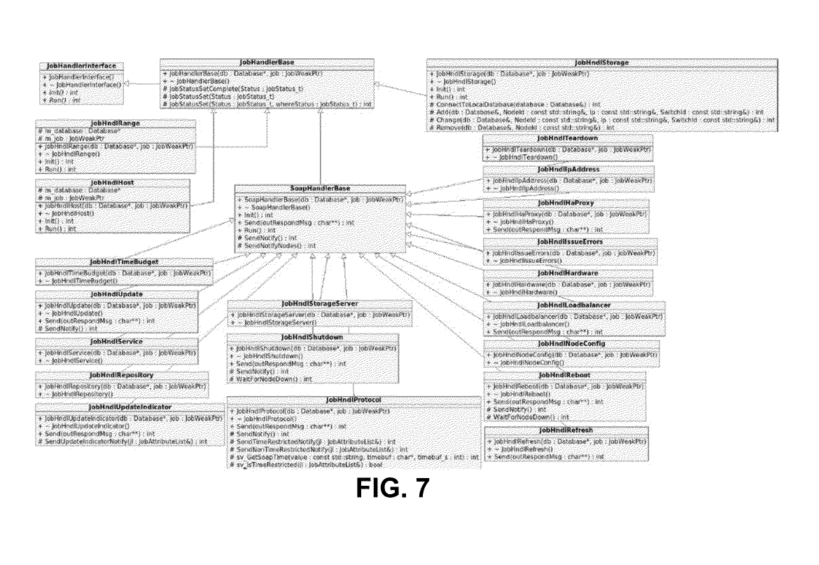

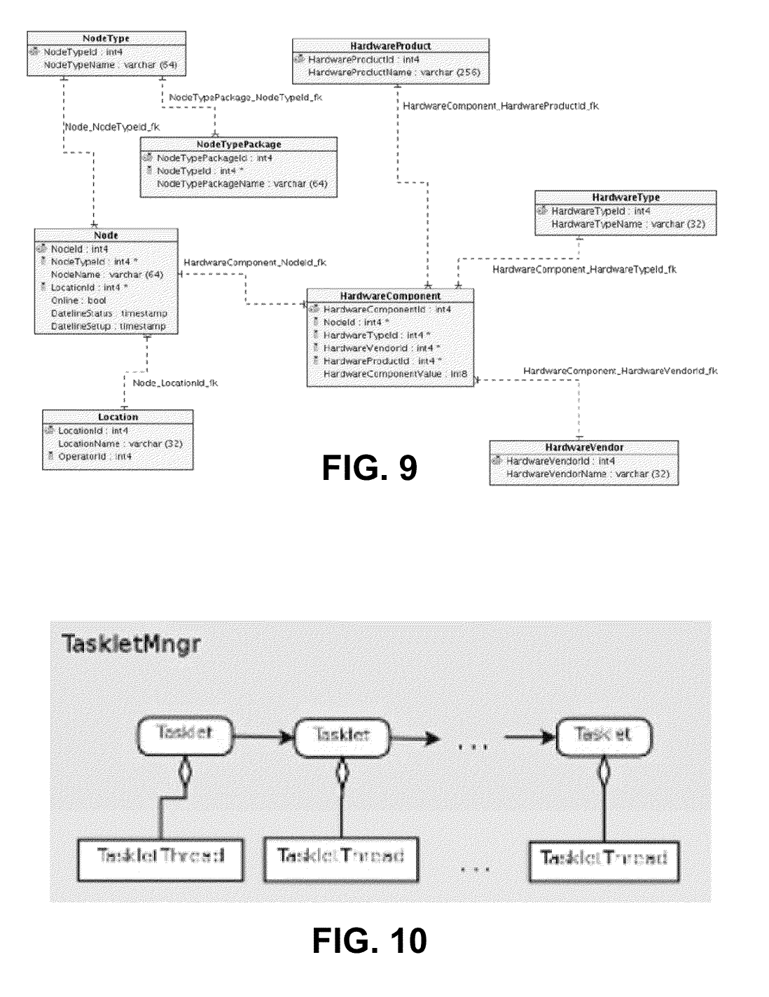

FIG. 6 is an exemplary Job table (and referenced tables) in accordance with one embodiment of the Job Dispatcher 122. FIG. 7 is a hierarchical diagram for an exemplary set of Job classes. FIG. 8 is a relationship diagram showing exemplary tables that correspond to the network's entities. It may be useful for extracting the IP addresses, NetworkType, etc. FIG. 9 is a relation diagram showing exemplary relationships between Node, HardwareComponent and Location.

With reference to FIGS. 6-9, a Job can be in one of the four states: ‘Pending’, ‘Processing’, ‘Successful’, ‘Failed’. Further, jobs may generally be scheduled based on their type (sequential/parallel) and the location of the target nodes—determined through the ‘NodeId’ attribute from the table ‘Node’. Here the location_id will be matching the one in the configuration file (/etc/node.conf). Always only one instance of the job-dispatcher will handle one location. The job readiness is determined with the help of the field ‘DatelineExecuteAfter’—if smaller than the current timestamp the job must be run. The next criteria for job loading is ‘JobStatusId’ but that depends on the state of application. On startup all jobs matching the first two criteria are read and stored to an internal list that have the status of either ‘Pending’ or ‘Processing’. After this is done only new jobs with the status ‘Pending’ are read. The interval in which this will be done is defined in the configuration file by the ‘JobRecheckInterval’ parameter. Next to retrieving new jobs in a regular interval the application looks out for status changes of the jobs that were received with status processing or set to this status. Here only the ‘JobId’s in request will be queried. When a job is processed the status will be set from ‘Pending’ to ‘Processing’ and the ‘DatelineBegin’ is updated.

Parallel and Sequential Lobs:

When handling pending jobs the field ‘JobExecuteType’ from the table Job is very important. If the value of this field is ‘parallel’ then the job is send out immediately if there's not another job with the status ‘processing’ for this node. If the ‘JobExecuteType’ is ‘sequentially’ the logic is far more difficult. Here it will be achieved that only one machine per group identified through ‘SwitchId’ of the internal interface and ‘NodeTypeId’ of the node has only one job with the status processing and only if that one is done the next job for a node within the group can be carried out. The reason behind this is that these jobs might be service affecting so that only one node of the group shall be out of service at a time while the others can take the offline node's workload.

SOAP Notification:

JobDispatcher sends a SOAP message after processing the job. All sent-out message responses are either “ok” or “error” with an error id and an error message. If the response is ok the status is not changed and remains on ‘Processing’. If the response indicates an error the job status is set to ‘Failed’. The job error details are saved in “JobError”. The ‘JobErrorTypeId’ is the error id that is coming back, the ‘JobErrorValue’ is the message that is coming back. One possible error (‘JobErrorTypeId’ 2) is that the remote node can't be reached and is not responding at all—in this case the JobDispatcher attempts the re-send the SOAP message for three or more times—the concrete number is defined in the configuration file (the parameter NumberOfRetries).

If a job is sent out or handled by the application itself depends on the job type. In the case of a SOAP notification type a TOP or HTTP connection to the remote host can be opened. If the ‘DestinationTcpPort’ configuration parameter is not empty then the application will create a TOP connection—otherwise it will use a HTTP connection. The IP address for the target node is extracted from the database—using the tables ‘Node’, ‘HardwareComponent’, ‘Interface’ and ‘NetworkAddress’ (SoapHandlerBase::Init( ), SoapHandlerBase::SendNotify( ) and Database::GetIpAddress( )). The actual building of the SOAP message may be provided by the external library ‘libsoap_adaper.so’.

JobTypeName ‘Storage’:

This job requires operations on the DB. For establishing a connection to the DB, the application uses the parameters PgLocalHost* from the configuration file. The Storage job has a attribute ‘Action’ that contains one of the following values: ‘Add’, ‘Remove’, ‘Change’. Depending on the action a record within ‘DownloadSite’.‘StorageServer’ is inserted, deleted or updated. The ‘JobAttributeTypeName’s represent the following fields in this case: ‘NodeId’->‘StorageServerNodeId’, ‘ipAddress’->‘StorageServerIp’, ‘SwithId’->‘StorageServerSwitchId’. On initial insert the ‘StorageServer Score’ will be 0. On update the ‘StorageServerNodeId’ shall be taken to identify the record to update or to remove, the ‘StorageServerScore’ is again set to 0.

JobTypeName ‘Host’:

The ‘Host’ job type handler alters the contents of a special file and afterwards a separate shell script will be executed that restarts a service (with content e.g. ‘/etc/init.d/dnsmasq restart’). The file that has to be altered is specified in parameter ‘DnsMasqConfigFile’ (e.g. ‘/etc/dnsmasq.conf’). Within this file the lines starting with ‘dhcp-host=’ are of interested. They will be parsed and divided into 4 pieces; ‘InterfaceMacAddress’, ‘NodeName’, ‘IpAddress’ and ‘HostLeaseTime’. Identifier is the ‘InterfaceMacAddress’. If this address matches the given attribute and the ‘Action’ is ‘Remove’ the complete line is removed from the file. Same case but the ‘Action’ is ‘Change’ ‘NodeName’ and ‘IpAddress’ are altered and their values are exchanged with the values from the attributes with the same name. If ‘Action’ is ‘Add’ after the last line that begins with ‘dhcp-host=’ another line is inserted. ‘HostLeaseTime’ shall always be taken out of the configuration file.

JobTypeName ‘Range’:

Here again the dnsmasq config file is altered. The file location shall be again taken out of the configuration file through parameter ‘DnsMasqConfigFile’ and when the alteration is finished the same shell script shall be executed like above. This time the lines are of interest that start with ‘dhcp-range=’. They are splitted into 3 parts ‘RangeStart’, ‘RangeEnd’ and ‘RangeLeaseTime’. Again the first entry the ‘RangeStart’ shah be seen as identifier. Like above depending on the actions rows are removed (‘Remove’), altered (‘Change’) or added (‘Add’). The ‘RangeLeaseTime’ will be taken out of the configuration file.

With particular reference to FIG. 7, various classes/internal components of the Job Dispatcher will be described.

As shown in FIG. 7, all classes may inherit JobHandlerInterface. This is an abstract class that have Init( ) and Run( ) abstract methods only. The JobHandlerBase class implements the basic functionality common to all jobs, also most jobs are derived from SoapHandlerBase class, see: Selected jobs hierarchy Job classes that have to send a SOAP message are inherited from the SoapHandlerBase class. The SoapHandlerBase class implements methods Init( ), Run( ) and Send( ) for creating and sending a SOAP message to the external Web service.

The JobDispatcher class is the main class—it implements the dispatching and job execution. The JobDispatcher::Run( ) method contains an infinite loop where a list of jobs ready to be executed is selected from the database each pooling interval (100 ms —default pooling interval). If the value of JobExecuteType is ‘parallel’ and if there's no other jobs with the status ‘processing’ for this Node then job is passed to the tasklet manager (TaskletMngr class). Also, if the value of JobExecuteType is ‘sequentially’ and no other jobs with the status ‘processing’ which is grouped by SwitchId and NodeTypeId then job is passed to the TaskletMngr.

The Database class is a wrapper for DB. This class implements all interactions with PostgreSQL database. Also, the Database class isolates the application level on the DB's specifics and structures. This class is based on pqxx library.

The TaskletMngr class is designed to control the parallel execution of jobs. The class contains a one-way list of instances of Tasklet class. Each Tasklet class contains an identifier of its thread. FIG. 10 is an exemplary block diagram of a TaskletMngr class executing tasklets. As shown in FIG. 10, each new job is placed in a free tasklet for execute. The method TaskletMngr::PutJob(JobPtr) is used for this. Class TaskletMngr has method TaskletMngr::PutJob(JobPtr). Class TaskletMngr may be realized as singleton and uses from a JobDispatcher class for running

Table 1 below sets forth an exemplary set of JobTypes and corresponding JobAttributes with exemplary values for in accordance with one embodiment.

TABLE 1
JobType and JobAttribute

| JobType | Dispatch: | Records: | Attibutes: | Example value: |
|---|---|---|---|---|
| Shutdown | Yes | — | — | — |
| Reboot | Yes | — | — | — |
| Update | Yes | N | Package | Squid |
| Repository | Yes | N | RepositoryKey | Main |
| | | | RepositoryName | Main Repo |
| | | | RepositoryBaseURL | [http://centos.org/5.3/sou rces] |
| IpAddress | Yes | N | InterfaceName | eth0 |
| | | | NetworkAddressValue | 192.168.10.10 |
| | | | OldIpAddress | 192.168.10.9 |
| | | | InterfaceMacAddress | 00:0B:DB:E7:29:FF |
| | | | NetworkNetmask | 255.255.255.0 |
| | | | NetworkIp | 192.168.10.0 |
| | | | NetworkGateway | 192.168.10.1 |
| | | | NetworkBroadcast | 255.255.255.255 |
| Service | Yes | N | ServiceName | httpd restart |
| | | | ServiceAction | |
| Hardware | Yes | — | — | — |
| HaProxy | Yes | N | WebFilter | 192.168.10.10 |
| | | | MailFilter | 192.168.10.11 |
| | | | ImFilter | 192.188.10.12 |
| LoadBalancer | Yes | N | WebFilter | 192.168.10.10 |
| | | | MailFilter | 192.168.10.11 |
| | | | ImFilter | 192.168.10.12 |
| Storage | No | 1 | Action | Add/Remove/Change |
| | | | NodeId | 12 |
| | | | IpAddress | 192.168.10.10 |
| | | | SwitchId | 45 |
| Host | No | 1 | Action | Add/Remove/Change |
| | | | NodeName | Webfilter01 |
| | | | IpAddress | 192.168.10.10 |
| | | | InterfaceMacAddress | 00:0B:DB:E7:29:FF |
| Range | No | 1 | Action | Add/Remove/Change |
| | | | Range Start | 192.168.20.0 |
| | | | RangeEnd | 192.168.20.100 or static |
| Refresh | Yes | 1 | Type | Account/Profile/General |
| | | | Id | 1234/NULL |
| NodeConfig | Yes | — | NodeId | 1 |
| | | | TunnelClusterId | 1 |
| | | | LocationId | 1 |
| Protocol | Yes | | CustomerId | 2 |
| | | | AccountId | 2 |
| | | | ProtocolId | 2 |
| | | | RuleType | Accept |
| | | | NetworkProtocol | TCP |
| | | | SourceIp | 192.168.0.1 |
| | | | SourceNetmask | 255.255.255.0 |
| | | | DestinationIp | 192.168.100.104 |
| | | | DestinationNetmask | 255.255.255.0 |
| | | | DestinationPort | 80 |
| | | | Start | 2010-09-11 00:00:00 |
| | | | End | 2010-09-11 23:59:59 |
| Teardown | Yes | | CustomerId | 2 |
| | | | AccountId | 3 |
| | | | ProtocolId | 4 |
| | | | NetworkIp | 192.168.10.0 |
| | | | NetworkNetMask | 255.255.255.0 |
| UpdateIndicator | Yes | | Type | 1 |
| | | | AccountId | 123 |
| | | | ProfileId | 45 |
| | | | CustomerId | 124 |
| TimeBudget | Yes | | AccountId | 1 |
| | | | ProtocolId | 2 |
| | | | TimeBudgetId | 1 add |
| | | | Action | 100 |
| | | | BudgetValue | 2010-09-11 23:59:59 |
| | | | ExpiryDate | |
| IssueErrors | Yes | — | — | — |
| StorageServer | Yes | — | IpAddress | 192.168.0.1 |
| TunnelStorageServer | Yes | — | IpAddress | 192.168.0.1 |
| InvokeVirusSignature | Yes | — | — | — |
| Up date | | | | |

### Web User Interface 114:

The Web User interface 114 may be used by all users of user devices as the entry point to: logging in or out from any device at home; use a search engine embedded in Web User Interface 114; get notifications when a web content is blocked (redirection from the Web Filter); and manage the filter settings. This user Interface may be used by parents to manage their filtering settings for themselves and their children.

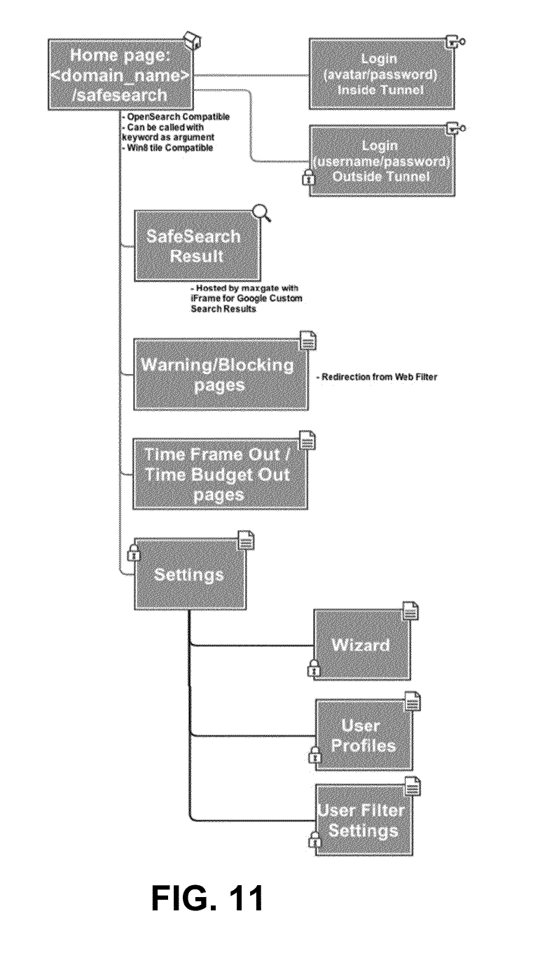

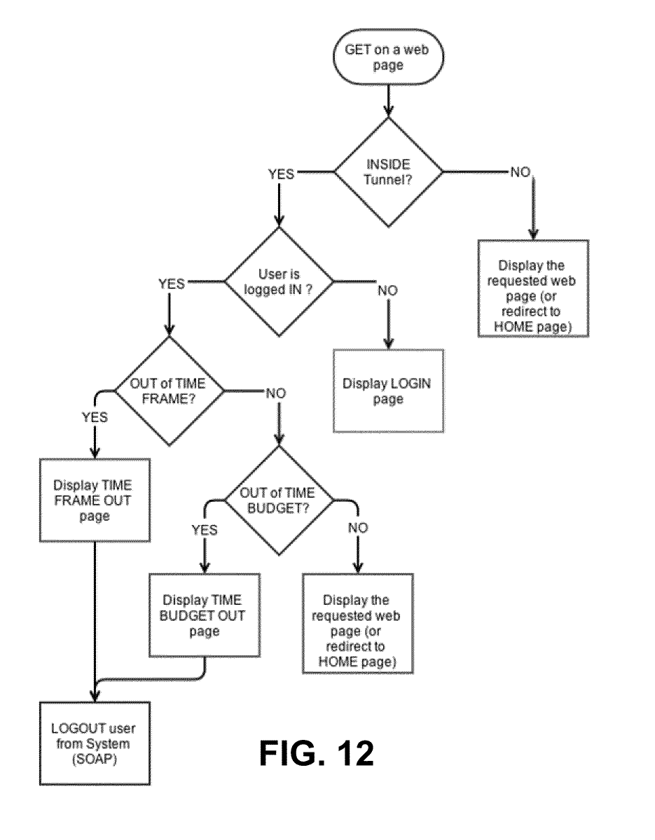

FIG. 11 depicts an exemplary site-map of a website of the web server 114. All those pages are not accessible for every one. This depends on some conditions. For example if the user is logged in or not, who he is (child or parent) and from where he accesses the web site (outside home or inside home). When receiving a request to serve one web page, the web server 114 performs some checks to determine whether access to a particular page by a particular is to be allowed by the system. FIG. 12 is a flowchart of an exemplary set of checks carried out by the system 100 when a user accesses the system (e.g., through web server 114).

The Web Site/Web Server 114 has several options to communicate with the System DataBase 116 where all the customer details are saved: Direct connection through SQL queries or REST API. The REST API gives central access to all the DB data (write/read) from the Web Interface any other application like a toolbar for example.

HOME Page:

With reference to FIGS. 11 and 12, the system 100 can support multiple resellers (who can decide to use different website URL). So each reseller's HOME page URL is stored in the DB (For example, maxgate GmbH is using http://my.maxgate.de as the HOME page URL). The Home page may be accessible by anyone in the Internet (from Office or from the Household). However, to access it from the household, the user has first to login as described in the next section. Once logged in he is automatically redirected to the HOME page. The Web server also may decide to perform some redirections internally. For example, Web server redirecting calls on HOME page to its /safesearch page when possible as shown in FIG. 12.

As shown in FIG. 11, two LOGIN pages may be provided: one for when a parent wants to access his family settings from the awat from how (i.e., not connected to the access point 104); and the other when an individual user wants to go to the Internet from the household (i.e., via the access point 104). When a parent wants to access his family settings remotely, the user will call the Home page and will click on a dedicated login button to access an Admin LOGIN page. He will have to enter his username and password to authenticate. In this case, he has an access to the family Settings but the user's access is not protected by the filtering functions of system 100. This is just administration purpose. When an individual user wants to go to the Internet from the household, any attempt to get any web page from a device at home on which no user is already logged in, is forwarded to the Web server (see the work flow above) by the Firewall (default IPtables rules is set to forward http requests to the Web server). The web server redirects then the request to the Login page where the list of users from this house is displayed. The user can simply pickup his name or avatar and login with his password. Each household (i.e., access point) is identified by a VPN TunnelId. This allows the Web server to identify which users are part of this family and then display the correct users's name and avatar on the Login page.

As shown in FIG. 11, the website may include a search engine. This search engine may include a search edit box from the Home page and/or an automatic search engine detection feature. The search edit box may be integrated in the HOME page but may be displayed differently depending on if a user is logged in or not, or the age of the logged in user (child or adult). For example, an option may be afforded that allows the parents to limit the surf of one child to only a list of pre-approved websites. In this case any request to any website which is not in this list will be forbidden.

The regular search edit box is developed from the Google search one. Performing a search with this search box, forwards the request to Google with the Reseller's partner number (maxgate has registered to Google Adsense program and got a partner number to use). This partner number is identified by Google and the results are forwarded to the Reseller's custom result page defined on the Google Adsense Control Panel. From this point, any click on ads provided with the results will be converted by Google into money for the Reseller. With the automatic search feature when rendering the HOME page, the Internet Browser automatically detects that an OpenSearch engine is available on this page, reads its parameters from an XML file located on the Server and adds it to its Search engine list. The user can display this list and, with one click, can decide to use this search engine by default for all his new search from the Browser URL edit box or the Browser Search edit box. When he does this, any search will be forwarded to the GateSecure search engine (with the keyword to search a parameter) and the results will be displayed in the /results page.

Warning/Blocking/Error Pages:

As shown in FIG. 11, when a user requests a web page which is found to be forbidden or questionable for the logged in user, or if an error occurs in the system while processing the request, the System 100 redirects the call to the embedded dispatcher.gatesecure.com web server with a number of parameters. Then, dispatcher.gatesecure.com analyzes this call and redirects it to the Reseller's website which will display either a Warning message to the user, a Blocking message or an Error message. The parameters passed in the redirection contain the user identification, and the reason for the redirection (for example, the Id of the filter which has found the bad content with the URL of the requested page). Those parameters are used by the Reseller's web site to compute the desired message to display to the user. A Warning will propose to the user to wave the warning and access the website. A Blocking will propose to the user to send a request to this website to the parents (through the embedded messaging system) or to let the parent unblocking this url on the fly (parents needs to enter his credentials in a form). An Error just advises the user to try later and the error is logged in the System for alerting the Sys Admin.

Time Frame Out and Time Budget Out Pages:

The Time Frame Out and Time Budget Out pages shown in FIG. 11 may be handled differently. When one of this time limitation is over, the Firewall may instructs the IPTables to redirect all the traffic to the Web server. Then, the next web request from the user is be received by the Web server which, as described in the Work Flow above, checks if one time limitation is over. If yes, it displays the Time Out page which contains to the user and logs hims out.

Settings Page:

As shown in FIG. 11, the website may include a settings page for setting filter settings for the system. For example, via this page, parents can decide which type of content should be blocked for each child. This is done through an easy to understand Interface where, for each category, then have the choice between “Allow”, “Warn” or “Block”. Each category displayed in the interface may be linked to one or more filter categories in the DataBase. Parents may also decide to log the activities of the children in the system and report them in the Activities section of the Interface. They can also decide to be notified by email or SMS when one child has been blocked by some filter categories.

### Firewall Node 110:

The Firewall node 110 (also referred to herein as FirewallServer) may be implemented as a Linux application written in C++. The main functionality of this application 110 is to add and remove IPTables rules. The parameters of these rules are fed in as a struct through a unix socket from the external application. In additional the FirewallServer monitors the using of IP addresses attached network and checks for new ones or ones that have timed out. During startup the application reads a parameters from configuration file. The application writes a log messages to a file and/or to the console with different verbosity. FirewallServer is able to start as a daemon and as a console application.

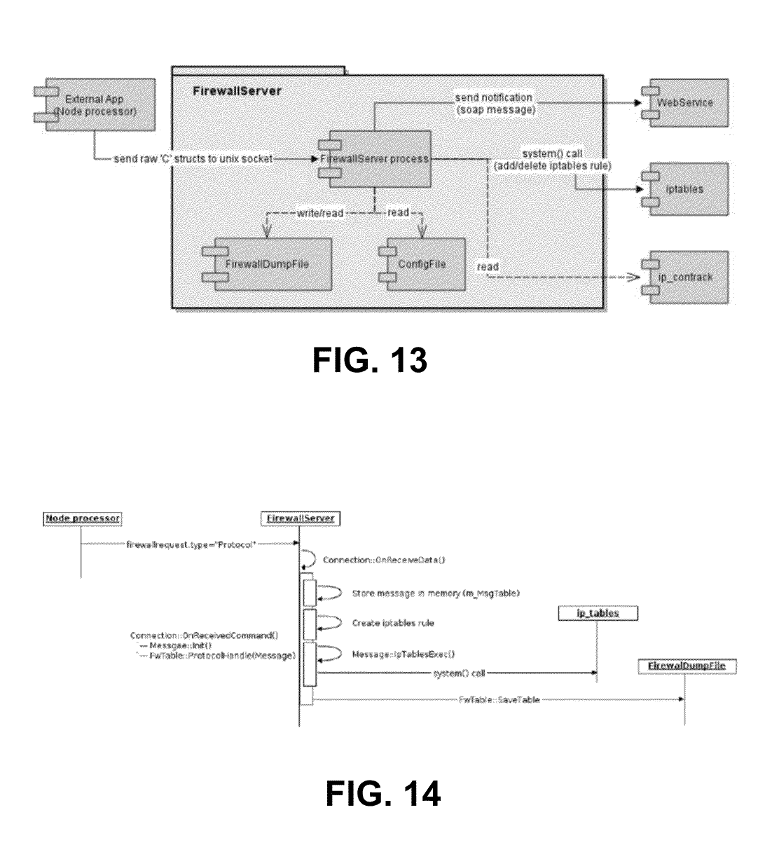

FIG. 13 is a block diagram showing the Firewall Node 110's interactions with other components of the system 100. As shown in FIG. 13, the FirewallServer 110 listens a unix socket and receives messages from the External App (NodeProcessor) 1302. After that, messages are processed by the FirewallServer 110 and added or removed as an iptables rule in the IPTable 1304. If FirewallServer 110 received and processed a timerestrict message the SOAP message is sent to a WebServer for notification. After processing of each message the FirewallServer saves it in the special FirewallDumpFile. This is done in order not to lose the rules in case of crashing the server.

As mentioned, actions of the FirewallServer may be initiated by messages which the server receive from the unix socket. In one embodiment, there may be three types of messages: “Protocol”, “Protocol with timerestriction”, and “Teardown” messages. FIGS. 14, 15, and 16 are sequence diagrams for implementing each of these three messages.

FIG. 14 is a sequence diagram for implementing a protocol message procedure. The Protocol message is a bunch of rules that is translated into iptables commands by FirewallServer. A ‘CustomerId’, ‘AccountId’ and a ‘Protocol Id’ are present in Protocol message. Next to that the message may have a time restriction flag. So that the rules within can't be applied immediately and have to be taken away again after some time. FIG. 14 shows a sequence of actions for the case without timerestriction. As shown in FIG. 14, the received message is stored in the internal memory (m_MsgTable). This is done to ensure the formation of the delete rules for iptables when the Teardown message will be received. If the rule is to be set it is translated into an iptables command. Parameters ‘IptablesExecutable’, ‘IptablesMainParameter’, ‘IptablesAddParameter’ and other ‘Iptables*’ from the configuration file are used to create the rule. For carries out of rule the FirewallServer used the system( ) call. Possible rules types include:

Accept—Accept the connection and forward it directly to Internet;
Redirect—Redirect the connection to HA-Proxy;
Gaming—Redirect connection to GS-Proxy;
Deny—Drop the connection; and
UserAccept—Accept the connection on pre-routing.

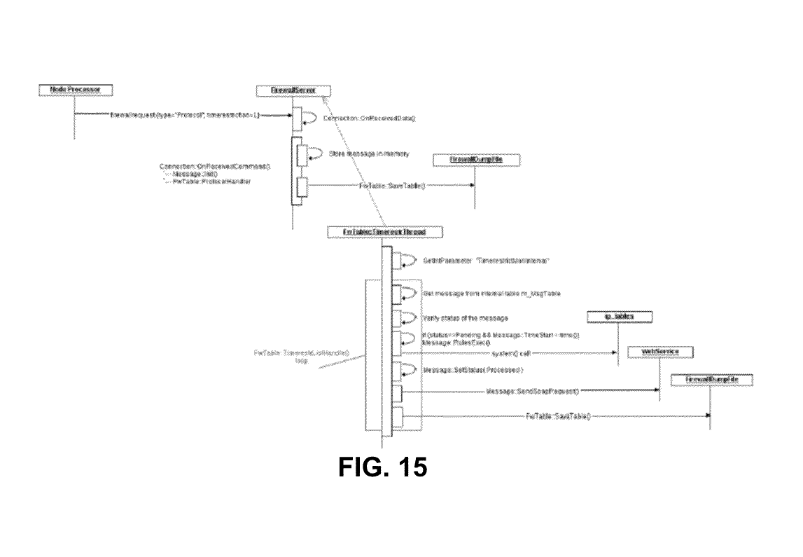

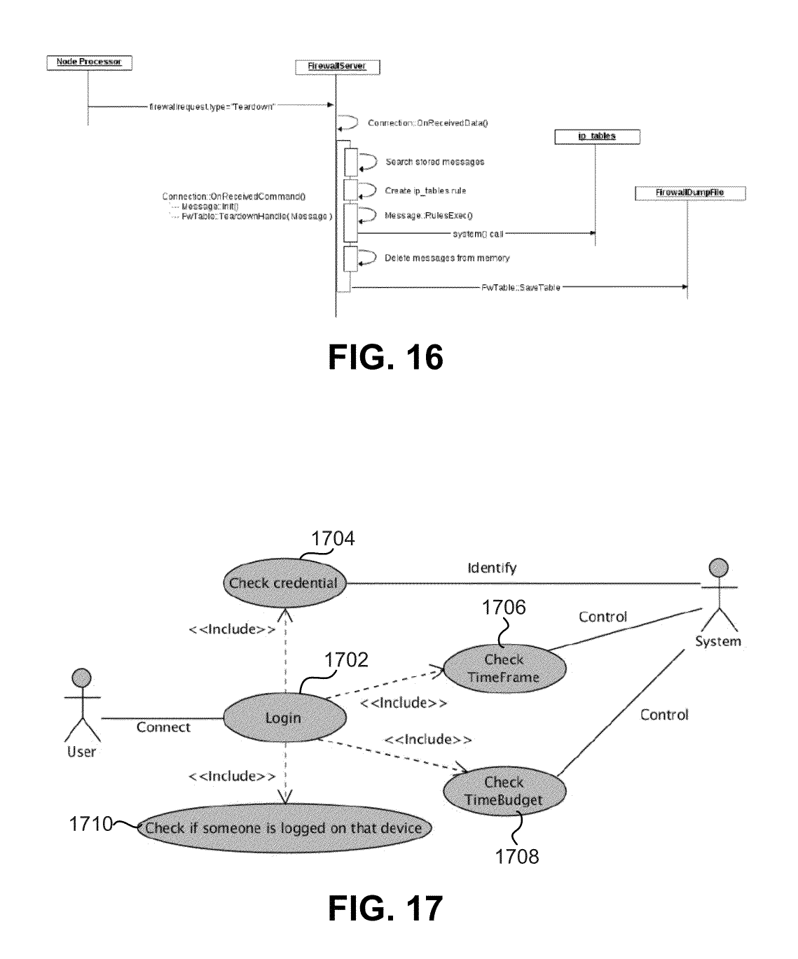

FIG. 15 is a sequence diagram for implementing a protocol with timerestiction message procedure. If a time_restriction flag of the Protocol message is set to 1 (yes), the process set forth in FIG. 16 will be implemented rather than the protocol process depicted in FIG. 14. In the protocol with timerestiction message procedure, TimerestrThread is used for processing of timerestrict messages separated thread. This thread uses a parameter TimerestrictMonIntervalfrom from config file for getting of time interval for verifying of internal table. All messages which have a status Pending and time restrict is begin will be translated to iptables rules and performed like a Protocol messages. After performing the special SOAP message will be emitted to the external web service for notification.

FIG. 16 is a sequence diagram for implementing a teardown message procedure. This procedure uses ‘CustomerId’, ‘AccountId’ and ‘Protocol Id’—but not all of these items need to be set. For each of these items, if it is received, every rule that matching it is removed. For example, if only ‘CustomerId’ is set everything where the ‘CustomerId’ matches is removed regardless of the other IDs. In other words, all records belonging to a ‘CustomerId’, ‘CustomerId’ and ‘AccountId’ or ‘CustomerId’, ‘AccountId’ and ‘ProtocolId’ will be found and removed.

Monitoring IPs in Use:

The FirewallServer 110 also monitors of the IP addresses currently is use in the network. To achieve this, a contrack table is utilized. The contrack table may be implemented as a separated thread IpContrackTable::IpContrackThread. The contrack table can normally be found in /proc/net/ip_conntrack but the FirewallServer used the ContrackTableLocation parameter from configuration file for opening this source. This file is read every ContrackTableRefreshInterval seconds—a value coming out of the configuration file. The ip_conntrack table may comprise of 1 to N records that may be set forth as follows: tcp 6 431999 ESTABLISHED src=192.168.0.100 dst=174.129.12.136 sport=39194 dport=80 packets=15 bytes=5278 src=174.129 dst=192.168.0.100 sport=80 dport=39194 packet s=14 bytes=2610 [ASSURED] mark=0 secmark=0 use=1

This line will be parsed and the IPs from a specific network which can be configured through the variable ‘ContrackTableInterestingNetwork’ will be extracted. Also when the record is parsed it will be checked if the IP address is inside an internal table consisting of IP and ‘Last seen’-timestamp. If is last seen is updated, if it's not the IP os added to the list with the current timestamp, and with this the SOAP notification ‘NewIp’ is fulfilled. After each time the list has been processed it will be checked if there are IPs on the internal list that haven't been seen for while. The concrete number for this time server reads from the parameter ‘ContrackTableAliveTimeout’ of the configuration file. If an IP address is'nt alive any more the SOAP notification ‘AliveTimeout’ is fulfilled.

Firewall Data Structures for Interactions:

The following data structures may be used by the Firewall Node 110 for interactions with external applications Node Processor and WebService.

Input Messages Structure:

The first message that the FirewallServer expects to receive a firewallrequest. There two types of messages that might come in: a “Protocol” or a “Teardown”. If the firewallrequest is a “Protocol” message and if the time_restriction field is equal 1 then the next structure have to be timerestrictions. If the firewallrequest is a “Teardown” message then FirewallServer expects an ip_info structure as the next.

SOAP Messages:

FirewallServer sends a SOAP notification messages to the external Web Service. There are messages ‘NewIp’ and ‘AliveTimeout’ for that. Creating and sending of SOAP messages are implemented in the SoapRequest class. This class uses an external soap adapter library.

Firewall Internal Components:

The Firewall 110 has at least three streams: (1) Server thread (main); (2) TimerestrThread; and (3) IpContrackThread. The Server thread performs the initialization of global data and running other threads. After that, it listens to a socket for incoming messages and processes them. The TimerestrThread performs the processing of Protocol timerestricted messages. See details above. The IpContrackThread monitors the new IP addresses. Threads use a wrapper class SelfDestrLocker for synchronized access to shared data. This wrapper class provides a safe locking of mutexes. For example, when using this class the global mutex not remain dosed when an exception occurs. The Firewall 110 also has a Configuration class that provides an access to the configuration file. This class uses a read_config( ) function from external library libconfread.so. Class Configuration may be implemented as singleton. The Firewall 110 may also have server and connection classes. These classes provide the communication framework. Server listens a unix socket for new connections and waits new data from the opened sockets. If new connection is bond the Server creates new instance of Connection class. Connection class performs reading and processing data from the socket.

IPTables:

Iptables is the standard firewall in Linux. There are two general possible use cases: (1) when a user is not logged in and (2) when a user is logged in. When a user is not logged in, the FirewallServer 110 does not know which iptables rules to insert for this device. As a result, default path may be followed for all the http request incoming from a non logged in user that will redirect the not logged in user to HAPaproxy 132 which redirect the user to the website provided by the Web Interface 114 for loggin into the system (see FIG. 11). When a user is logged into the system, the rules for allowed protocols for the user are inserted into the before redirection. Those rules will allow specific port to access Internet, redirect them to specific services or block them.

To avoid getting some duplicated or missing firewall (iptables) rules after a Tunnel fresh start or restart, a iptables_gs script may be called when shutting the tunnel down. This script calls a database function that cleans all the previous entries including: Main.device.account (set to the current date/time); Spooler.deviceLog.EndDateline (set to the current date/time); and System.TunnelSession.EndDateLine (set to the current date/time).

### User Authentication:

FIG. 17 is a diagram of a login decision process in accordance with one embodiment. As shown in FIG. 17, during login 1702 by a user seeking access to the Internet, the system 100 may need to check the credentials of the user (i.e., authenticate the user) 1704, check whether the user is still within a predetermined time frame 1706, check whether the user still has any time remaining in a predefined time budget 1708, and even check whether any other user is also loggin in to the system on the same user device 1710.

As previously described, each user connected to the household network or to the office network, using a device protected by the system 100, must login to the system 100 before being able to surf or use Internet. This allows the system 100 to identify the particular user and load his or her specific settings which define what communications and content will be allowed and which will be blocked by the filters. User login can be done either manually or automatically. In manual login (via Web Interface 114), by default, all the HTTP traffic is redirected from the Tunnel to the Webserver using an iptable rule. After a user logs in from a device the HTTP traffic from that device is no longer routed to the WebServer—again using iptables rules—and the user can browse. As part of this process, protocol jobs are used: each user has a specific protocol configuration (i.e., user-specific iptables rules for specific protocol ports), protocol job messages (for each protocol) are generated to set up the system 100 for filtering Internet communications by use the user. this protocol configuration is applied using for each “protocol”. When a user configures a device for autologin, the specific device is logged in with the specified user account. The user will remain logged in until the autologin is removed for the device. For such device, there may not be login time-outs.

### User Logout:

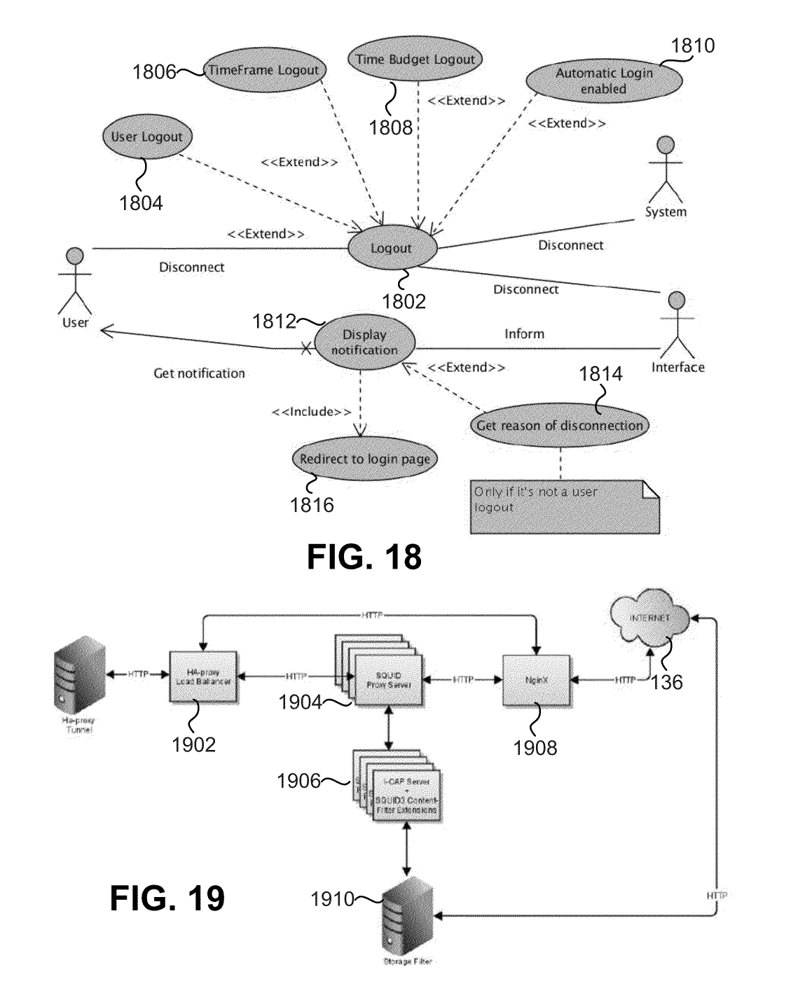

FIG. 18 is a diagram of a logout decision process in accordance with one embodiment. As shown in FIG. 18, to achieve a logout 1802, the system may check: (1) whether the user is attempting to affirmatively logout 1804; (2) determine whether logout is required because of passage of an elapsed predefined timeframe since login 1806; (3) determine whether a predefined time budget for the user being logged in or using the system has been exceeded 1808; (4) whether automatic login has been enabled for the user 1810. Upon determining a reason for logging out, the system may also need to remove the iptables rules associated from that user from the firewall/iptable; notify the user of the logout 1812 and possibly inform the user of the reason for the logout 1814; and redirect to a login page 1816. Thus, when a time restriction is set, the firewall may automatically remove the IP rules that allow the user to go to Internet. The user will then be redirected to the interface but is still logged in.

When the user logs out a sequence of actions similar with the one for login takes place: the webserver sends a SoapLogout message to the Worker who then inserts a Teardown job for the tunnel on which the customer is connected and one UpdateIndicator logout message for each node on the same “location” as the connected tunnel. When the teardown job is executed the iptables rules that allow to a user to browser will be removed and all HTTP traffic will be redirected again to the WebServer node. The Teardown job is responsible of removing the protocol configuration for the user:

The system may also implement an Automatic Logout on as a result of an Inactivity TimeOut where the user is logged out after no activity by the user is detected for an elapsed amount of time. In such a situation, the FirewallServer application that runs on the Tunnel node monitors the IP addresses currently in use on the network. To achieve this the contrack table is monitored by a separated thread IpContrackTable::IpContrackThread. This file may be read periodically (e.g., every ContrackTableRefreshInterval seconds—a value coming out of the configuration file).

In an exemplary implementation, the ip_conntrack table may comprise 1 to N records having a format similar to the following:

tcp 6 431999 ESTABLISHED src=192.168.0.100 dst=174.129.12.136 sport=39194 dport=80 packets=15 bytes=5278 src=174.129 dst=192.168.0.100 sport=80 dport=39194 packets=14 bytes=2610 [ASSURED] mark=0 secmark=0 use=1

This line will be parsed and the IPs from a specific network which can be configured through the variable ‘ContrackTableInterestingNetwork’ will be extracted. Also when the record is parsed it will be checked if the IP address is inside an internal table consisting of two rows: the IP and ‘Last seen’-timestamp. If the IP is found the last seen value is updated, if it's not the IP is added to the list with the current time-stamp and then the SOAP notification ‘NewIp’ is sent. After each time the list has been processed it will be checked if there are IPs on the internal list that haven't been seen for while. The concrete number for this time is defined by the parameter ‘ContrackTableAliveTimeout’ in the configuration file. If an IP address is'nt alive any more the SOAP notification ‘AliveTimeout’ is sent which triggers a complete logout (the worker creates Teardown and Update Indicator jobs that are then sent by the JobDispatcher)

Automatic logout may also be implemented so that the user is logged out when a predetermined time frame or time budget has been exceeded after the user logged in. When a user has defined a time frame or a time budget the closest time left until the expiration of any of these two metrics is computed at login and passed as part of the protocol jobs.

In such an embodiment, the system may also need to check the following whenever the user attempts to log in: (1) the credential of the user; (2) whether the user is still inside the predetermined Time Frame from the initial login, (3), check if the user still have some predetermined time left in his or her predetermined time budget; and (4) check if the user was previously logged in on that device. If the predetermined time amounts have been exceeded, login will be denied and the now unauthorized user may be displayed an appropriate message indicating that the relevant time amount has been exceeded or elapsed. This implementation may be used, for example, in situations, where a parent or guardian wishes to restrict the amount of time that a child accesses the Internet—both in duration (i.e., elapsed time frame) and overall usage (i.e., time budget). For example, the parent may which to restrict the child's Internet access to no more than 30 minutes at any given time with no more than 2 hours of access in a single day, week, month, etc.

### Web Filter Nodes 124:

The Web Filter Nodes 124 (also referred to herein as WebFilter modules) may play a major role in the filtering system 100. In general, the job of a Web Filter 124 is to analyze Outgoing and Incoming HTTP requests, and either pass them through to the Internet 136 (in the case of Outgoing requests) or to the authenticated user (in the case of Incoming requests), or block them according to one or more filter rules.

FIG. 19 is a schematic diagram of an exemplary web filter 124. As shown in FIG. 19, on the webfilter there is a local chain of programs, applications and/or functions that handle incoming HTTP requests from a user. Starting the from the right, the HA-proxy 1902 makes load balancing on one or more SQUID instances 1904. The Squid instance(s) 1904 forward the HTTP request to GS-ICAP 1906 where the content of the request accordingly to the filtering rules. Once a content is identified, the routing is done to the correct destination. Further, once processed by SQUID/GS-ICAP the request may be passed to NginX 1908 which forwards the query to the Internet 136. As shown in FIG. 19, in certain embodiments, the request can be forwarded from the HA-proxy 1902 to NginX 1908 directly. A storage filter may also be included 1910.

### HA-Proxy:

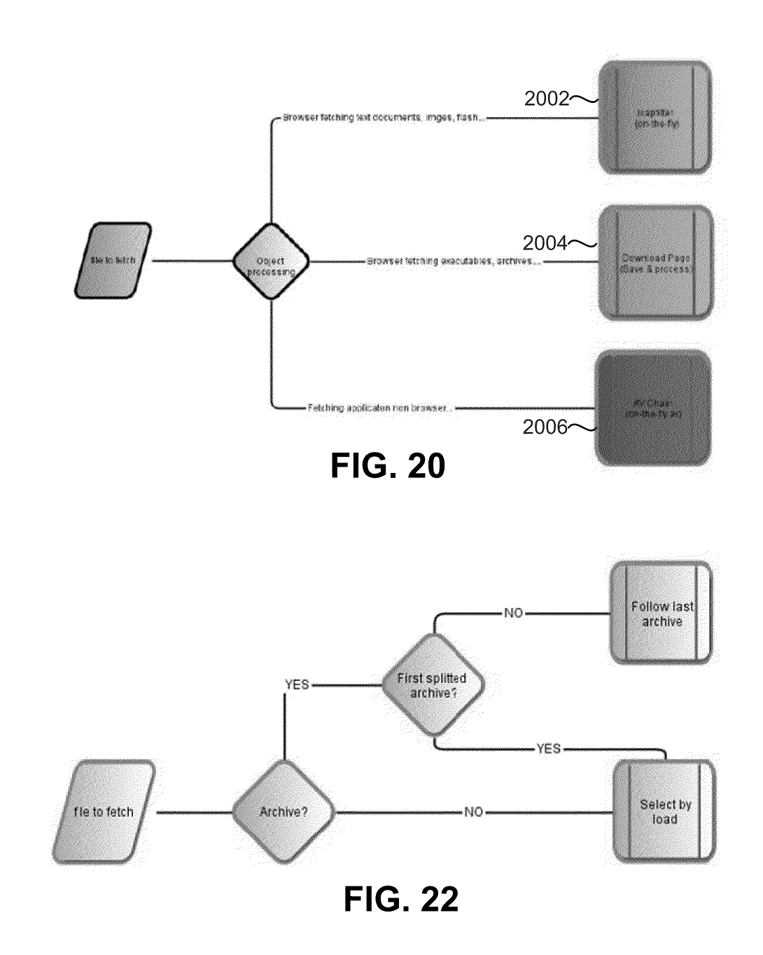

On the Webfilter, HA-Proxy 1902 may be used for two tasks: (1) to make some load balancing between the different instance of SQUID (default behavior); and (2) to redirect request for specific host to nginx directly (occasional; to bypass squid). FIG. 20 is a flowchart of routing cases of an exemplary HA-Proxy. As shown in FIG. 20, there are three possible ways to scan and handle an object:

Case 1. Files that are typically shown within the browser (mime types: text/, image/, application/x-pdf, etc.) 2002;
Case 2. Files that are accessed through the browser but are typically downloads (executables, archive files, movies . . . ) 2004; and
Case 3. Files that are not accessed through the browser (e.g. software updates, updates that are fetched through application's own HTTP clients) 2006.

Case 1 may be handled on-the-fly by the icapfilter. Case 2 may be handled by the download page on a different physical node where the file first is fully fetched and then analysed and—if it's clean—offered for user download. Case 3 may be handled through a chain of different third party icap filters: ClamAV, Kaspersky and BitDefender. In the third case only on-the-fly virus filtering is applied.

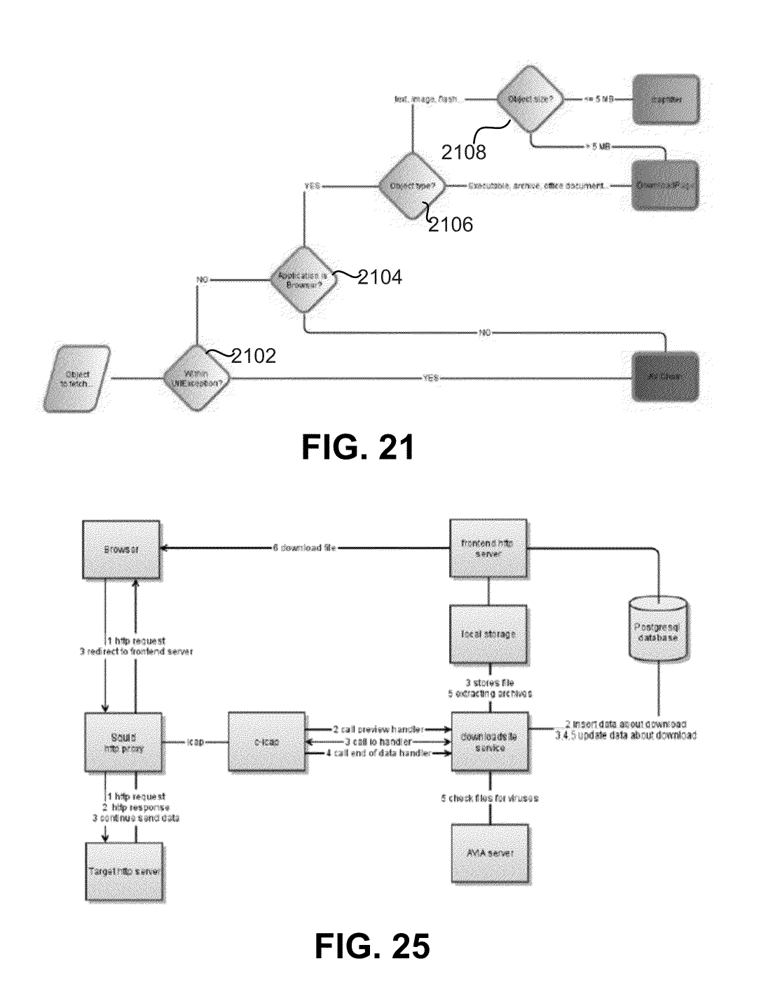

FIG. 21 is a flowchart of an exemplary decision making process for a HA-Proxy. The table “UriException” holds URL patterns which—if they match (box 2102) on a part of the requested URL —lead to a chaining decision right away. This is a user-unspecific fallback to ensure that specific URLs aren't handled through the on-the-fly scanning or the download page. As shown in FIG. 21, one decision 2104 is whether a browser is used to fetch the object or not. Only with a browser user interaction with the download page is possible. If just an automatic updater fetches the object (like adobe reader or similar) it will not be able to understand the download page that is coming back. As a result, the browser is recognized with the help of the tables UserAgent, UserAgentPattern and RoutingOption it can be determined if the requested user application is a browser or not and if chaining should be used or not. The check should be based on the user agent in the request headers. This user agent can be identified from the request header with the mapping to the table “UserAgentPattern”. If a pattern from this table is found within the user agent string of the request header the user agent is identified (simple matching). If nothing can be identified chaining shall be used. If chaining is used the appropriate headers are set in the ICAP header (“X-Next-Services”, this value is squid specific, the concrete value has to be taken out of the configuration file).

The on-the-fly scanning may be handled through the icapfilter and the attached avia server. With the help of the table MimeTypeSetting, MimeType and RoutingOption it can be determined if a detected mime type should be handled this way or through the download-page (box 2106). If it should be handled this way the AVIA server is passed the active scan engines for a Profileld and which values to use for image scanning.

While in general all images, texts and other stuff that is shown in browser is handled on-the-fly through the icapfilter there's still one exception: When the file is to big—which should be configurable in the config file (maxContentlength parameter)—the complete download should go to the download page (box 2108). The reason here is to avoid that really large images or artificially created images or texts use up all RAM on the webfilter node where the files are not stored to disk like on the download node.

Storage Server Selection:

FIG. 22 is a flowchart for selecting a storage server. When a download is identified that should be downloaded through the download page a storage server has to be identified or better it's service name. There are two ways to identify a storage server: In case the requested file is part of a packed archive with multiple parts the file has to be stored on the same storage server the other files went to. The tables “StorageDatabase” and “ArchiveTracking” will help here. A multi volume archive is only identified by filename with striped out digits. The other way to identify the correct storage server is by “load” with the help of the table “StorageServer”. Here the entry with the highest score should be chosen. Again the hand-over to the download page is handled through an ICAP header telling squid that the traffic should be directed there next (“X-Next-Services”, db service name lookup).

SQUID/I-CAP Servers:

Basically, the WebFilter module may be implemented by a SQUID3 Proxy Server acting as a I-CAP client as follows.

### Outgoing Requests Content-Filtering:

Keyword Scan:

When this function is enabled, the Filter looks for User-Specific keywords within each URL and/or HTTP request. Keyword filtering works as follows. On the UP direction (requests initiated by the user)—the URL and the HTTP request are searched for blocked keywords occurrences (these are defined in the GUI in the Interaction TAB/Personal, and are stored in the schema Keyword.ProfileValue) or blocked language groups (group keywords)—keywords that are part of content Groups defined in Keyword.Group table. The keywords in the GroupValue table can actually be sentences (e.g.: “The devil is in details”). The keyword filter will return after the first match for a specific group (single word or sentence) and depending on the action specified for this tuple of (group,profile_id) it will: continue (if action is do nothing), redirect to a blocking page if action is block, redirect to a warning page if the action is “Warning” (the user is warned that the file requested could be dangerous, etc. and ask if it is sure it wants to go there . . . ). In some embodiments, there may be no filtering on the DOWN direction (incoming content). In another embodiment, if down directly filtering is implemented, the filter may search both the URL and the content of the page for profile specific keywords (the same as on UP—because the value of “direction” column from the Keyword.ProfileValue table is not taken into account) or group keywords. The filtering may be done through the Keyword module in the Webfilter project that in turn uses the libkeyword library for actual keyword parsing and matching.

Forged Birthday Detection:

When this function is enabled, the Filter detects when a GET or POST request contains a date (with 4 digits for the Year, 2 digits for the Month and 2 digits for the Day). If this date is more than 18 years before the actual date, then it blocks the HTTP request and replaces it by a GET request on a new URL (Blocking page) along with some parameters.

File Upload Restriction:

When this function is enabled, the Filter checks each File transmitted within the HTTP requests. If the File Type or Extension is forbidden, then it blocks the HTTP request and replaces it by a GET request on a new URL (Blocking page) along with some parameters.

Incoming Request Filtering:

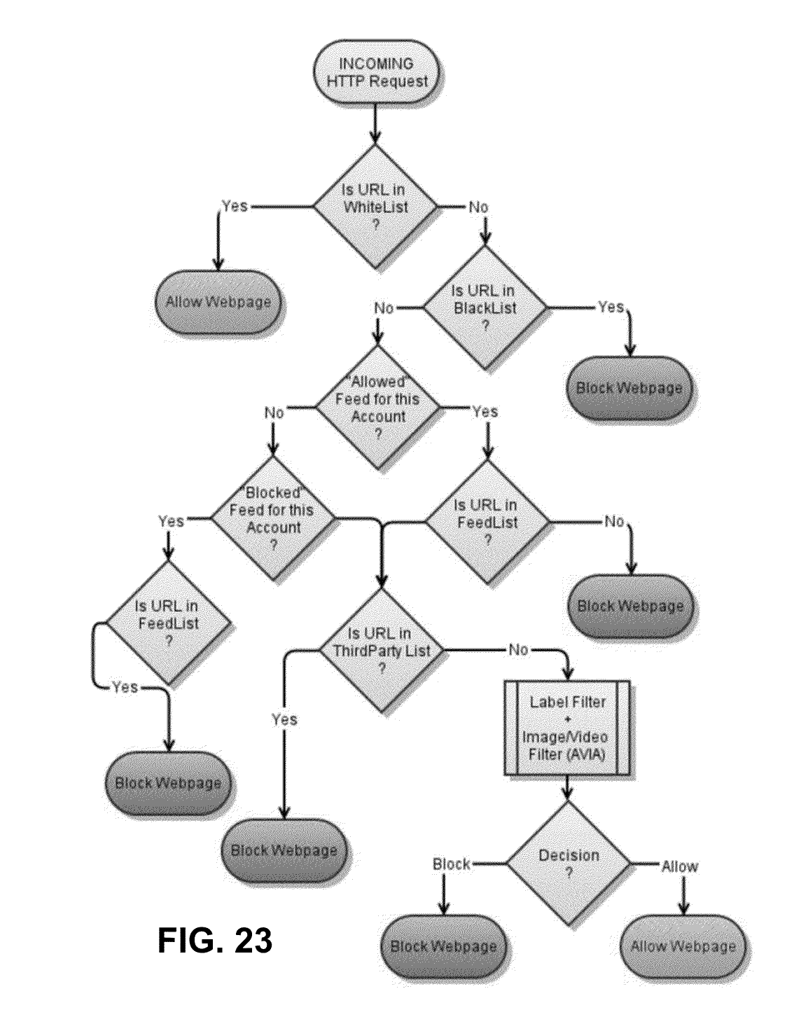

FIG. 23 is a flowchart for an exemplary process for filtering incoming requests. As shown in FIG. 23, several filters may be used on Incoming Requests which are described below.

By White and Black Lists:

As shown in FIG. 23, the filtering of incoming requests may include URL filtering by White and Black Lists. A Whitelist is a list of URLs (either complete URL or subpart of a URL) stored in the database for one account, that must not be blocked by the Filter whatever all the other restrictions are. In the white list step, the filter compares the requested URL with the Whitelist. If it is found in the list, it allows the webpage. It is not found in the list, it proceeds with the other Filtering features described in the section.

A Black is a list of URLs (either complete URL or subpart of a URL) stored in the database for one account, that must be blocked by the Filte whatever all the other permissions are. In the blacklist step, the Filter compares the requested URL with the Blacklist. If it is found in the list, it blocks the webpage and redirects the browser to a new URL (Blocking page) along with some parameters. It is not found in the list, it proceeds with the other Filtering features described in the section.

By Feeds:

A Feed is a list of URLs (either complete URL or subpart of a URL) stored in the database, that can be either inappropriate or appropriate for some user categories. As shown in FIG. 23, when a Feed List is enabled for an account, the Filter compares the requested URL with the Feed list. If the Feed type is considered as inappropriate for the user, the Filter blocks the webpage and redirects the browser to a new URL (Blocking page) along with some parameters. If the Feed type is considered as appropriate for the user, the Filter allows the webpage and only the URLs listed in the Feed list will be allowed to this user.

By Third Part URL List:

As shown in FIG. 23, when a Third Party (Commercial or Free) URL List is enabled for an account, the Filter compares the requested URL with the URL list. Depending on the URL Type, the Filter makes the decision between allowing or blocking this page. When the decision is to block it, it redirects the browser to a new URL (Blocking page) along with some parameters.

### Content Filtering:

Language Detection:

When this function is enabled, the Filter detects the Language used within the received webpage (looks only for mime-type “text/*”). If a Not Allowed Language is detected, it redirects the browser to a new URL (Blocking page) along with some parameters.

Label Detection:

When this function is enabled, the Filter looks for known labels (ICRA labels) within the received webpage (looks only for mime-type “text/*”). When one is found, it makes the decision between allowing or blocking this page. When the decision is to block it, it redirects the browser to a new URL (Blocking page) along with some parameters.

Image Detection:

When this function is enabled, the Filter looks in a signature database for a match with the signature of the incoming image url. If the image is found—it is blocked and replaced with a blocking image.

Image File Analysis:

When this function is enabled and if the image was not blocked by the image detector, the Filter analyses the image file linked within the received webpage. Depending on the image analysis result, it makes the decision between allowing or blocking this image. When the decision is to block it, it replaces the image link by a defined new one (Blocking image) in the received webpage.

Video File Analysis:

When this function is enabled, the Filter analyses the video file linked within the received webpage. Depending on the video analysis result, it makes the decision between allowing or blocking this video. When the decision is to block it, it replaces the video link by a defined new one (Blocking image) in the received webpage.

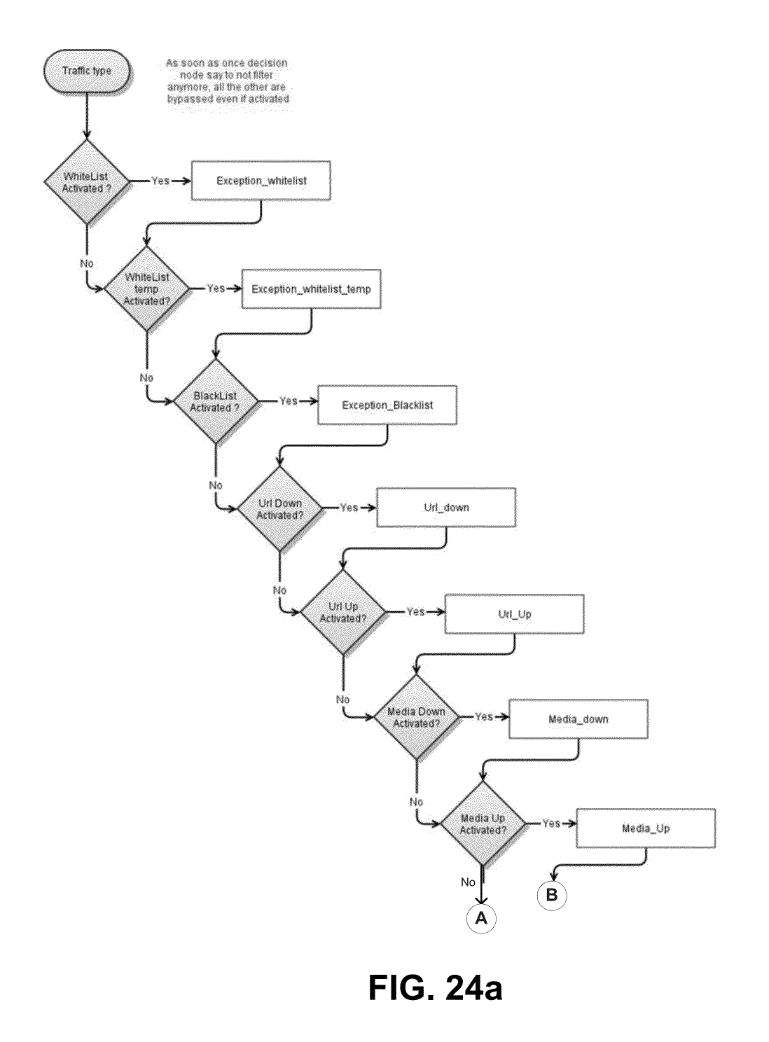

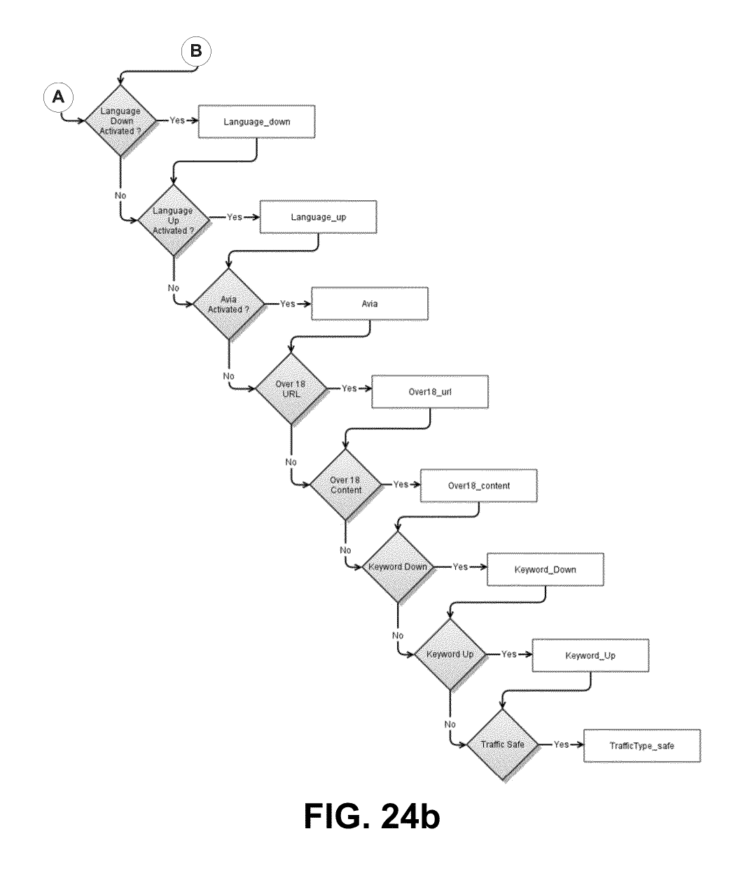

FIGS. 24a and 24b depict an exemplary flowchart illustrating a process that a Web Filter may use in determining which filters to apply. To get the filter available for the current step, the system may use a filter list for headers, a filter list for preview, a filter list for content, and a filter list for stream. This value is used a bitmask in the flowchart depicted in FIGS. 24a and 24b. In this flowchart, each of the webfilter may result in one of the flowing statuses:

ROUTING_OPTION_CHAINING: process the next AVS;
ROUTING_OPTION_NOCHAINING stop processing this content;
ROUTING_OPTION_ONTHEFLY: continue to process the request;
ROUTING_OPTION_DOWNLOADPAGE: Change next service to Downloadpage;
ROUTING_OPTION_STREAM: Change next service to Stream (allow); and
ROUTING_OPTION_UNKNOWN ROUTING_OPTION_CHAINING continue as normal.

File/Media Filter Node:

Embodiments of the system 100 may include a File/Media Filter node/module. This node may be used to filter media in upload and/or download. In general, the content type is identified and then checked by the desired modules. The File/Media Filter Node may perform Streaming and/or Content type Detection

Content is classified in categories by the system. These categories are used to determine whether a user can view the content. Exemplary categories include: 1. text: text file content; 2. streaming: all streaming content (mp3, mpg); 3. document: MS office files, pdf; 4. audio: all audio format; 5. video: all video format; 6. executable: ms-dos exe; 7. archive: zip, 7zip; 8. Misc (Most of the time MimeType of third party application (could be anything, video, sound, etc)); 9. image (image file format); 10. Feed; 11. unknown (application/octet-stream, force-download); and 12. necessary (needed category).

Stream Detection:

Stream may be detected with a combination of multiple parameters including: 1. Content type must be: Application/octet-stream; and 2. Content length must be: 0 or a very high number or Server type must be: GVS (google video server) or specific mime types linked to stream content type in the DB.

Content Type Detection:

In content type detection, the filter checks for the type of content. Content type detection may be used to route correctly content incoming or outgoing from/to WEB to specific filtering chains accordingly to the category of the processed material. Because they are multiple way of setting content type the filter first checks the content_type header. If it's not set, the filter looks after mime-type value in the header. If the filter still does not know what is the content type of the file currently processed file, it may then look at the file extension. After this, if all checks failed, the filter processes it as standard html/text page.

Image Detection/Image File Analysis:

The IMDetect module is in charge of picture content filtering. Violent images and pornographic images are filtered by this module. The image signature is a compilation of the image features which allows matching images at different scales and resolutions (third party module). If the image is found—it is blocked and replaced with a blocking image. The content may also be checked inside for viruses.

Depending on the image analysis result, the filter makes the decision between allowing or blocking this image. When the decision is to block it, it replaces the image link by a defined new one (Blocking image) in the received web page. The Image Analyzer is used for this check. Image Analyzer is a solution for detecting sexually explicit image content. The technology can quickly and accurately analyze an image or video to determine if it contains pornography. Image Analyzer is licensed on an OEM basis to software vendors and service providers across a broad range of market sectors. http://www.image-analyzer.com

Video File Analysis:

When this function is enabled, the Filter analyses the video file linked within the received web page. The analysis is done by splitting the movie stream in individual image frames and using the Image File Analysis to decide if these are pornographic. Depending on the video analysis result, it makes the decision between allowing or blocking this video. When the decision is to block it, it replaces the video link by a defined new one (Blocking image) in the received web page. The system may rely on an Image Analyzer for this check.

Streamed Data Processing:

Streaming data is data that is processed by client (browser/flash plug in) on the fly, e.g. flash video, Internet radio. It is typically downstream data (from http server to http client). Normally webfilter waits for all data before sending it to client. However, in case of streamed data it causes big latencies or data timeouts.

Preview Handler:

Streamed data is detected by its content type (CategoryId 2 in Media.Mimetype table) in routing_{—} preview function. For data that is determined to be streamed follow action occurs:

info->rqd.is_streamed_data=1; flag shows that data is streamed
ci_req_unlock_data(req); cause c-icap to request data from webfilter before end of data handler
content_storage_lock(info->rqd.content_storage); to prevent data sending before filtering

IO Handler:

Whenever data is received in streamed request(info->rqd.is_streamed_data==1), the IO Handler, handle_stream(main_flow.c), may be called. The IO Handler (Handle_ stream) checks that unprocessed data size if greater than min_stream_block_size(streamBufferSize parameter in configuration file). It is done to prevent frequent processing small chunks of data, which can cause high cpu load. The IO Handler (Handle_stream) then applies stream filters to unprocessed data. Next, the IO Handler (Handle_stream) updates info->rqd.stream_processed_size and calls content_storage_unlock_current(info->rqd.content_storage); to unlock current data in storage buffer so it can be sent to client.

Downloadable Content:

In case of content that will be downloaded by the user, the webfilter redirect the request to downloadsite. Downloadsite is a c-icap module which downloads file to local storage, extracts it if the requested file is archive and checks its content for viruses. Browser gets the file through frontend http server.

FIG. 25 is a flowchart of a process for processing downloadable content using a downloadable service node/module. As shown in FIG. 25, the browser requests file from server (flow item 1). On download start (flow item 2), the server responds, c-icap calls preview handler, preview handler queries account and profile data from database, and preview handler inserts information about file into database. Next, in flow item 3 (Downloading), http server continues send file, c-icap calls io handler, io handler stores file to local storage and updates progress in database, and io handler sends redirect to frontend to browser. In flow item 4 (Download finished, c-icap calls end of data handler, end of data handler updates database, and end of data handler puts requests into queue. Next, file processing is implemented (flow item 5) where the monitor thread pulls requests from queue, extracts files, sends files to virus server. The monitor thread also updates database. Finally, in flow item 6 (Processing finished), the browser downloads file from frontend server.

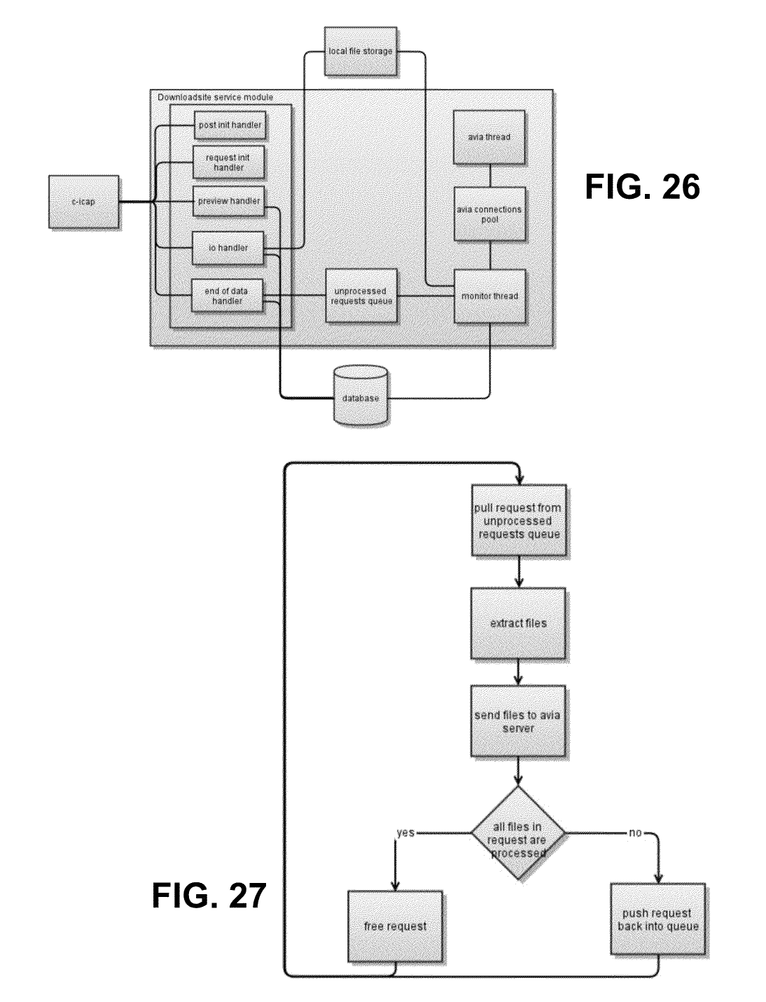

FIG. 26 is a block diagram of an exemplary downloadable service node/module capable of carrying out the process depicted in FIG. 25. As shown in FIG. 26, the downloadable service node/module includes c-icap handlers and a post init handler(srv_post_init) which are used on load initialization. The node also may include init request handler(srv_init_request) which allocates memory for request data. The preview handler(srv_preview) serves to create file on disk and insert a record for the request in the database. An io handler(srv_io) in included in the node to save content into file and to update the request data in the database.

The function of the end of data handler(srv_end_of_data) is to update the request data in the database and put the request into queue.

After file is downloaded, the monitor threat is used to extract it if it is an archive file and then forward it to the avia threat to scan the extracted content for viruses. This process is illustrated in FIG. 27 which is a flowchart of a process for extracting and scanning contents using the monitor thread and Avia thread. In general, the monitor thread does not wait for answer from avia server since it can take long time. Instead, the monitor thread sends the file content to the avia server using avia connections pool. The avia (anitvirus) thread then polls active connections from avia connection pool, and then reads and processes answers of the Avia (antivirus) server.

### Game Filter Node/Module:

One goal of the connection daemon is to control the use of games played online by children and connections to HTTPS servers. Connection daemon is executed on a server that is a default gateway for client PC and all traffic web, mail, gaming etc. is going through that gateway. Connection daemon is able to monitor all connections a client PC tries to establish and can map each PC to an account that is currently logged on to that PC using PostgreSQL data base server. The account always represents a child and is connected to a profile with specific settings. All incoming client connections are first handled by an iptables firewall allowing, disallowing or redirecting them to filters. All the new TCP/UDP connections with destinations ports higher than 1024 are handled by the connection proxy daemon that analyzes if the connection is established to game server or not and allow or deny the connection. Connection daemon may utilize libgprobe functionality to enable game detection feature. For the purpose of monitoring HTTPS connections all TCP connections to port 443 are forwarded to netfilter queue by iptables as well.

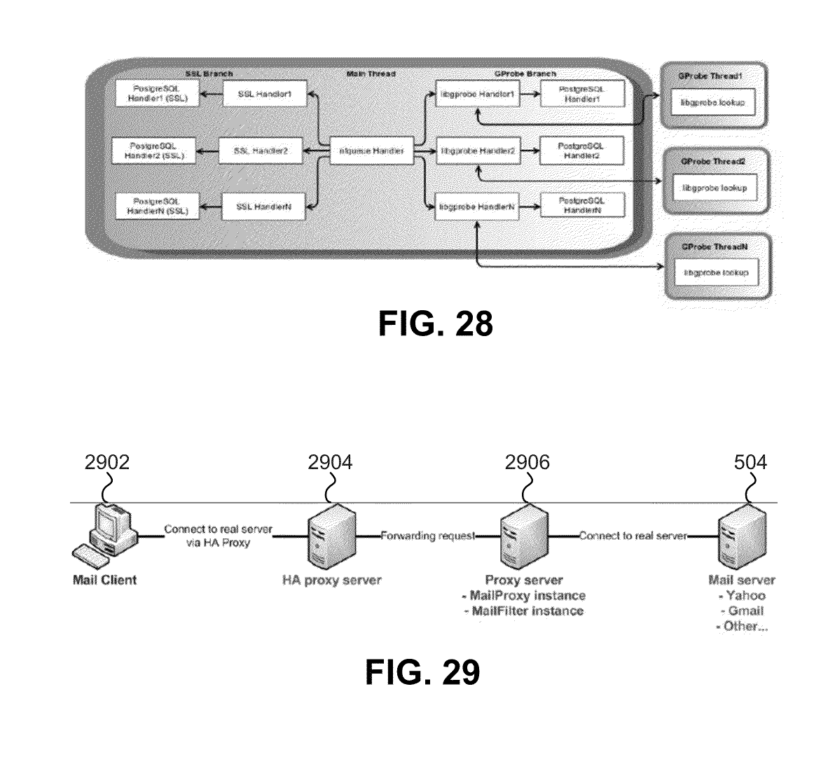

FIG. 28 shows connection daemon functional diagram for the game filter node. As shown FIG. 28, the SSL branch is on the left side and the GProbe branch is on right. The connection daemon is a multithreaded application comprising of two types of threads: Main Thread and GProbe Threads. There is one Main Thread and it is responsible for processing all the events in the system for every connection being monitored by the daemon at that moment. At the same time, there may be multiple GProbe Threads each executing libgprobe lookups for a single server by means of gprobe_ctx_lookup function. GProbe Thread is started by Main Thread and reports its results back to the Main Thread. The components of the game filter node are discussed below.

Main Thread and Event System:

The Main Thread monitors events from different sources and executes appropriate handler when each event occurs. Global event and timer systems help to implement this. These systems provide similar functionality to one provided by libevent. Events associated with target file descriptor are registered within global event system. File descriptors may be in non-blocking mode. Events are such as file becomes available for reading or writing. When event occurs an associated callback function is executed. If event does not occur within predefined period of time then another callback function is executed. As all callback functions are executed from the same thread, execution time should ideally be as little as possible to minimize the latency of the other callback functions pending for execution. For this reason, it may be useful to avoid blocking calls in callback functions. Long execution time of GProbe lookup is the reason why it is executed in a separate thread. Event System utilizes epoll(7) notification facility.

Events from the following systems are monitored by Main Thread:

nfqueue—Event is raised when new packet is available in netfilter queue;
PostgreSGL—Communication with PosgreSQL server is a process that passes through different states. When transition between such states occurs an event is raised;
GProbe Thread—Communication between Main Thread and each GProbe Threads is done via pipes. In Main Thread pipe becomes available for reading when GProbe completes execution and pushes execution results to the pipe write end; and
SSL—Communication with SSL server is a process that passes through different states. When transition between such states occur an event is raised.

GProbe Thread:

The GProbe Thread is created by gprobe_lookup_init connection daemon function and simply executes gprobe_ctx_lookup libgprobe function [in a context of the new thread. When lookup completes its result is written to the pipe. The results can be read by mean of gprobe_lookup_get_result functions while the pipe reading end file descriptor can be taken by means of gprobe_lookup_get_fd routine. It is worth pointing out that all packets, that include ones from different users and/or to different servers, may be processed by a single nfqueue Handler in context on Main Thread. When packer is processed in GProbe branch it is either accepted or declined and are marked with 13 after that. This mark helps iptables not to put processed packet back to netfilter queue. Packets can be accepted or declined by means of nfqueue verdict or iptables utility. The last avoids processing similar packets multiple times. Such packets are not forwarded to nfqueue and accepted or declined by iptables. It allows to process other packets from nfqueue much faster and improve overall system efficiency.

nhqueue Handler:

The nhqueue Handler processes all incoming packets. As previously mentioned, iptables should be configured such a way all the packets connection daemon is interested in (FORWARD packets) to be forwarded to netfilter queue the connection daemon is bound with. Once packet is available in a queue an event is raised and nfqueue Handler is executed by Event System. One purpose of nfqueue Handler is to perform initial packet processing and initiate further processing in GProbe thread to recognize the game server, SSL handler and PostgreSQL handler to check if the user initiated connection is allowed to connect to the server (game or SSL) or not.

When invoked nfqueue Handler executes the following steps. First, it performs some basic packet filtering that is duplication of iptables filter set (if it FORWARD or PREROUTE packet etc.). The nfqueue Handler also checks whether packet is of TCP or UDP type and accept it if it is not. AH further processing is executed for TOP and UDP packets only. For these types of packets, nfqueue Handler checks if destination server is TOP SSL and if so executes SSL processing otherwise executes the next steps (See SSL Processing clause).

The nfqueue Handler also monitors the number of GProbe Threads running at the moment and if it does not exceed a threshold continues further processing. If the maximum number of threads have been reached the new packet is accepted. The nfqueue Handler further checks if the same Row Node is already in Cache and if it is not then GProbe Thread is started for that Row Node to determine game server type. Once GProbe Thread has been started the file descriptor, through which lookup results can be read, is registered within Event System and gprobe Handler is associated with it. Once libgprobe completes execution, an event is raised and gprobe Handler is called. The handler is also called explicitly if Flow Node has been found in Cache that means gprobe lookup results for destination server have been already available and therefor there was no reason to execute gprobe lookup again. If for whatever reason Row Node processing can not be started due to either thread number exceeds a threshold or gprobe lookup is being executed at the moment and its results has not been available yet then Row Node is accepted by means of nfqueue accept call (nfqueue verdict).

libgprobe Handler:

The libgprobe Handler executes as a callback function called when lookup results becomes available. It is called in a context of Main Thread and executes the following actions depending on gprobe lookup result:

GPR NONE: execute port lookup (see Appendix A) and if game is found in port lookup table Flow Node is allowed by means of nfqueue verdict otherwise processing is continued with querying PostgreSQL server (see PostgreSQL Querying section);
GPR CIRCUM: Connection is declined by means of nfqueue verdict;
GPR GAME: processing is continued with querying PostgreSQL server; and
GPR ERR: connection accepted by means of nfqueue verdict.

Libgprobe:

Libgprobe is a library that is able to detect a specific game that is played on a remote game server by just having IP address and game port as arguments. The Libgprobe library API can be divided into 3 sections: (1) Global initialization; (2) Context initialization; and (3) Lookup.

Global Initialization API:

The API functions of the Global Initialization API group operates with gprobe_t structure. The structure contains values of parameters read from configuration files and other auxiliary data fields. Global initialization API may include of three functions: gprobe_init, gprobe_destroy, and gprobe_reload. The function “gprobe_init” dynamically allocates memory for gprobe_t structure, reads configuration files, initializes logging subsystem etc. This function should be called once and before any subsequent libgprobe API call. The function “gprobe_destroy” closes log file and frees dynamic memory allocated by gprobe_init function. This function must be the last libgprobe API being called. The “gprobe_reload” function reloads QStat and reverse IP configuration files. This function is thread safe as all data fields initialized from QStat and reverse IP configuration files are protected by mutex. Being a thread safe this function may be called at any time of libgprobe execution.

Context Initialization API:

As one of the library requirements was to provide ability to check several servers at a time, it implies to introduce library context, the entity being created for each server under the check. The data structure describing the context is gprobe_ctx_t. The structure gprobe_ctx_t contains data fields related to each lookup stage. The context initialization API includes two functions for gprobe_ctx: gprobe_ctx_init and gprobe_ctx_destroy.

Function “gprobe_ctx_init” dynamically allocates memory for gprobe_ctx_t structure and performs initialization of AMAP, memcached client an QStat components to communicate with a single server. If one needs to communicate with several servers then several gprobe contexts must be used. They can be used in separate threads. Global library initialization with gprobe_init must be done before using this function. Function “gprobe_ctx_destroy” destroys all gprobe components (AMAP, memcached client etc.) and frees dynamic memory allocated by gprobe_ctx_init routine.

Lookup API:

Lookup API includes five functions. Four of them execute their particular lookup stage while the fifth executes all stages sequentially. Lookup function is executed for particular server and thus operates within its gprobe_ctx_t structure. The five lookup API functions include gprobe_ctx_check_circumvention, gprobe_ctx_lookup_memcached, gprobe_ctx_lookup_qstat, gprobe_ctx_lookup_reverse_ip, and gprobe_ctx_lookup.

The gprobe_ctx_check_circumvention function executes circumvention detection by means of AMAP functionality for a specified server. The gprobe_ctx_lookup_memcached function executes memchached lookup stage for a server checking if addr:port pair exists in cache of memchached server. The function gprobe_ctx_lookup_qstat executes QStat lookup stage for a server trying to identify a game using QStat functionality. The gprobe_ctx_lookup_reverse_ip execute reverse IP lookup stage for a server trying to find its host name within a list of restricted hosts. The gprobe_ctx_lookup function executes full lookup: circumvention detection and 3 lookup stages for a server.

Checking Server Circumvention:

Checking Server Circumvention is a stage of the Lookup section of Libgprobe and ensures server being checked does not try to bypass subsequent lookups. On this stage, it is checked that that on the remote port neither a HTTP, SSL, POP3, IMAP, SMTP nor SSH servers can be found. AMAP utility is used to implement this functionality (http://freeworld.thc.org/thc-amap).

AMAP source code is integrated into libgprobe project. Original AMAP implementation was not intended to be used in multithreaded application as global and/or static variables were used all over the project. Such variables are replaced either with local variables or dynamically allocated ones. In the last case the pointers to dynamically allocated variables are stored in gprobe_ctx_t structure. Some unnecessary AMAP code was wrapped with #ifndef AMAP_STRIP pre-processor statement that excludes it from compilation. AMAP logging functionality was replaced with one provided by libgprobe library. No any other significant changes in underlying AMAP algorithm were introduced. AMAP is configured such a way to detect only the server types listed above. Such configuration is done in amap.trig and amap.resp configuration files. The underlying AMAP algorithm simply sends some query messages corresponding to server type being checked either over TCP or UDP protocol and then checks if the replies received matches ones expected for these server types. For example while checking if server is SMTP server AMAP sends “HELO AMAP\r\n” TCP message to the server and if its reply is “̂220 .*mail” (treated as Perl regular expression) then server is detected as supported SMTP protocol.

AMAP is invoked by amap_main routine called from gprobe_ctx_check_circumvention. This circumvention mechanism, with the help of SSL filtering, allow us to block TOR networks. If the HTTPS filtering system is used in white list mode, it may specify which URL the system may want to allow. By that meaning it can block TOR certificate. TOR will then try other high ports to access his network. As soon as an HTTPS connection is detected on a port which is not the normal HTTPS port, it may be blocked.

Memcached Lookup Stage:

Memcached Lookup Stage is also a stage of the Lookup section of Libgprobe. The ID of the game executing on the server is checked on this stage by querying memchached(1) server (http://memcached.org). The search key is “IP:PORT” of the server and the result if any is a game ID. The memcached server is executed and configured properly from libgprobe configuration file. Libmemcached API is used to access memcached server. The value stored in memcached server are placed or updated there at the end of gprobe_ctx_lookup routine in case game is detected. If game is not detected then entry for “IP:PORT” of this server is not added to memcached. The game ID is stored in memcached server for predefined number of seconds specified by MemCachedExpiryTime parameter of libgprobe configuration file.

QStat Lookup Stage:

QStat Lookup Stage is a stage of the Lookup section of Libgprobe. This stage tries to directly detect the game running on the server. It is achieved utilizing QStat 2.11 functionality (http://qstat.org, http://gstat.sourceforge.net/). QStat source code is embedded into libgprobe project and is adapted to be a thread safe by replacing global and static variables with local and dynamically allocated ones. Similar to AMAP adaptation, the pointer to dynamically allocated QStat data are stored in gprobe_ctx_t structure. Lots of QStat local functions is modified such a way to use variables supplied as function parameters usually by means of pointer to qstat_t structure. QStat context. Besides that modification, unnecessary code is wrapped #ifndef QSTAT_STRIP pre-processor statement and is excluded from compilation. QStat logging functionality is also replaced with one provided by libgprobe. Each QStat engine query game server with specific messages and waits for its reply. If reply matches to one expected for that engine type then game is detected. Otherwise it is not.

Reverse IP Lookup Stage:

Reverse IP Lookup Stage is yet another stage of the Lookup section of Libgprobe. Reverse IP lookup stage is a straightforward implementation of libgprobe requirements. Reverse lookup of the server IP address is done by means of getnameinfo(3) routine of Linux API. If a result is retrieved (server host name) it is striped to the last three parts (separated through dots) and is looked up against the list of domains set in reverse IP configuration file. The loop up is done in revip_lookup routine. If there is no match another part of server host name is taken away and is looked up again host list. If there is a match then game ID corresponding to the match is exacted from configuration file. If not then game is not detected.

Full Lookup:

Full Lookup is part of the Lookup section of Libgprobe. Full lookup is implemented in gprobe_ctx_lookup routine as per libgprobe requirements [1] and sequentially calls gprobe_ctx_check_circumvention, gprobe_ctx_lookup_memcached, gprobe_ctx_lookup_qstat and gprobe_ctx_lookup_reverse_ip routines. If at whatever stages server circumvention or game ID is detected the further lookup stages are not executed. Game ID detected if any if added (updated) to memcached server at the end of gprobe_ctx_lookup.

Libgprobe Game Data:

Libgprobe relies on the existence of a way to map a pair made of a protocol and a TCP/UDP port to a specific game, and more exactly to a specific gameid in the gatesecure database. For this purpose the gamerulemapping.conf file is used. Budding this file may require merging information from multiple sources. Besides the game/protocol/port mapping libgprobe uses the known game servers information present in the memcached db in order to speed up the lookups.

A python application built over the gslist opensource application may be used to query the gamespy servers for known game servers IPs and the games that the servers are associated with. In this way, a database of known game servers is constructed that can be regularly updated. If the destination IP of the packet matches one of the know servers, the system concludes that the communication is part of a game communication and depending on the game with which the server is associated and the settings for the account logged in on the originating device the communication is allowed or blocked.

PostgreSQL Handler:

As shown in FIG. 28, a PostgreSQL Handler is responsible for establishing connection with database server, sending it SQL queries, receiving results from database server and calling appropriate callback function to process the results received. Sending SQL query to PostgreSQL server is done with postgres_dispatch routine. It executes the following:

(1) Checks if Keepalive has any connection and if so reuse it, while if it did not then the new connection with server is initiated by means of libpg API;
(2) Connection file descriptor available either from Keepalive or from libpg API is registered within Event System and PostgreSQL handler is registered as a callback function; and
(3) Handler state is set to pg_state_connect

libpq makes PostgreSQL file descriptor available either for reading or writing to inform about events occurred. When file descriptor event occurs PostgreSQL Handler is called. Its actions depend on the state and are as follows:

(1) pg_state_connect: Connection is established. SQL query is sent to PostgreSQL server and the handler state is set to pg_state_get_result:
(2) pg_state_get_result: PostgreSQL server replies with results. The results are taken with libpg API and callback function (supplied to postgres_dispatch as an argument) is called to process them. The state is set to pg_state_idle; and
(3) pg_state_idle: When handler is invoked being in this state it means that connection completes and can be closed. If there is a room in Keepalive the connection is stored there for future use while if room is not available the connection is closed and appropriate data structure is freed.

PostgreSQL Querying (GProbe Branch):

With continuing reference to FIG. 28, a set of consecutive SQL queries may be issued to PostgreSQL server. This sequence are initiated from libgprobe Handler. Each next steps is initiated in callback function of the previous step. The sequence is as following:

(1) Query for profile, account and customer ID's;
(2) When above ID's are available issue explicit lookup query. Further actions depends on action ID and time restriction returned by PostgreSQL:
(a) If Accept action ID without time restriction is returned the connection is allowed;
(b) If Decline action ID is returned then connection is declined;
(c) If Accept action ID with time restriction is returned then time restriction SQL query is sent to PostgreSQL server;
(d) If PostgreSQL query returned no results then implicit lookup SQL query is sent to PostgreSQL server;
(3) Time restriction lookup query is issued to determine if current time is within an allowable time frame. Further actions depends on query results:
(a) If the current time is withing allowable time range then connection is allowed;
(b) If the current time is out of allowable time range then connection is declined;
(c) If PostgreSQL query returned no results then implicit lookup SQL query is sent to PostgreSQL server;
(4) Implicit lookup query. Game ID returned on reply to this query is compared against ID from gprobe or port lookup stages and if there is a match connection is accepted otherwise it is declined.

SSL Processing (SSL Branch): SSL processing on the SSL Branch side of FIG. 28 includes several steps. First, a check is made to see if the connection is already in cache. If it is not then new connection_t is created and added to the cache. Otherwise if connection is in cache, then it is updated and its SSL state is checked (see below the explanation about SSL states). If SSL connection is not is SSL_ST_DONE state then connection is denied.

Further processing creates ssl_t object which has several states:

SSL_ST_NONE: To determine if connection to SSL server is allowed or not one has to get canonical name from server SSL certificate, therefor connection to SSL server needs to be established. But before establishing a connection memcached server is checked if there is already a certificate for that server already in memchached. If it is so then connection to SSL server is not established and processing moves to SQL querying (by means of ssl_dispatch_db_processing call). But if canonical name is not in memcached then connection to SSL server is established and SSL certificate is requested from the server. It is implemented in SSL Handler.
SSL_ST_CONNECTING and SSL_ST_SSL_CONNECTION: establishing SSL connection with the server.
SSL_ST_GET_CERT: Once SSL connection is established SSL certificate is retrieved from the server to get canonical name from it and once it is done one proceeds with PostgreSQL server being queried to check if the server with that canonical name is allowed to be connected or not.
SSL_ST_DB_QUERY: Querying PortgreSQL server.
SSL_ST_DONE: SQL query is replied and the connection is either allowed or denied

SSL Handler:

The SSL Handler(s) in FIG. 28 process the following states of SSL connection life cycle: SSL_ST_CONNECTING, SSL_ST_SSL_CONNECTION and SSL_ST_GET_CERT. The handler is registered within Event System and is called when event on SSL socket occurs.

PostgreSQL Handler (SSL Version):

The SSL version of PostgreSQL handler illustrated on the SLL side of FIG. 28 is very much similar to GProbe version with two differences. First, the PostgreSQL Handler (SSL Version) operates with different data structures (pgengine_t vs struct pg_data). Second, the SSL version API matches better OOD concept as all functions have pointer of pgengine_t as the first argument. It was not so in GProbe branch version. When PostgreSQL handler is executing sst_t state is SSL_ST_DB_QUERY.

PostgreSQL Querying (SSL Version):

With reference to the SSL side of FIG. 28, two consecutive SQL queries are issued to PostgreSQL server. This sequence is initiated from SSL Handler. Each of next steps is initiated in a callback function of the previous step. First, a query for profile, account and customer ID's is carried out (Query have been modified to take in account per profile feeds). Next, when these ID's are available, SSL common name lookup query is issued. If there is an entry in PostgreSQL server for the canonical name then SSL connection is allowed by marking it with 14 while if there is no entry then SSL connection is declined by marking it with 15. Once PostgreSQL server replies with the result to the query the ssl_t state becomes SSL_ST_DONE. Those query have been modified to allow all the HTTPS website which are not into the account Black List. The query have been extracted from HA-Proxy and it's now a function in the Database (check_https(Profile Id, Common Name)).

### Mailfilter Nodes 126:

Mail Filters 126 are used for filtering emails and have two components: a Mail Proxy for handling the connections between mail server and mail client, and a Mail Filter for filtering the content of the emails.

### Mail Proxy;

Mail Proxy is transparent, robust, scalable application server stands between Mail client and Mail Server to scan email for multi-purpose by writing a plugin and deployment.

FIG. 29 is a diagram of a network topology for filtering email by the filtering system 100. The Mail Client 2902 is a User/Customer mail client program such as: Microsoft Outlook, Mozilla Thunderbird, Apple Mail, Envolution. The HA proxy server 2904 is a proxy server that redirects and forwards traffic from client to Proxy server 2906. Proxy server 2906 include instance of Mail Proxy and Mail Filter. Mall Proxy accepts connection and connection to real server, process request/response, transfer completed email to Mail Filter. Mail server 2908 is a real mail server such as Yahoo Mail, Gmail or some mail provider.

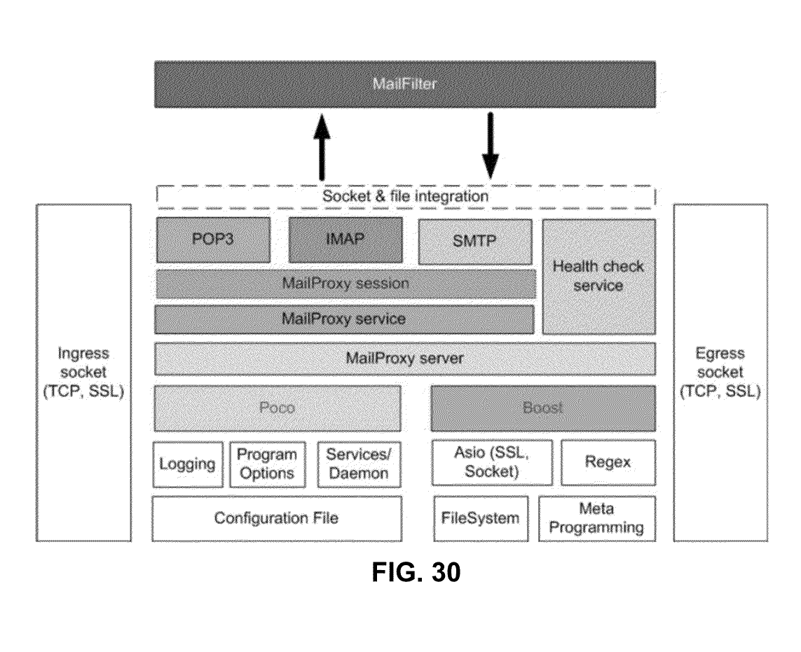

FIG. 30 is an application stack diagram illustrating various components of the Mail Proxy. These components are described as follows.

Poco Component:

It's Poco library which provide many utilities for Mail Proxy such as:

Logging: Data, message, trace log base on level to file or console output.

Program options: Mail Proxy provides many options for uses. Program option is parameter of Mail Proxy.
Services/Daemon: Mail Proxy can run in daemon mode on Linux or Windows Service.
Configuration file: Providing XML-base configure.

Boost Component:

Boost library support algorithm functions, utility, string format, regular expression support.

Asio: Asynchronous i/o server for socket. Mail Proxy use is as asynchronous socket network.
Regex: Regular expression. Currently, Mai Proxy doesn't use it.
FileSystem: Handling create mail file.
MetaProgramming: Binding method technical and anxiary method.

Mail Proxy Server Component:

Instance of Mail Proxy which run and perform actions:

Loading configuration from file;
Initial, start mail protocol service;
Parse program option and run in daemon or service mode; and
Load plugin and provide to service.

MailProxy Service Component:

Presentation of mail protocol service. It listens and accepts connection, create socket, connect to mail server. It establishes connect between client and server side via Ingress/Egress socket.

Ingress socket: Client-side socket for reading, writing data and closing connection.
Egress socket: Server-side socket for reading, writing data and closing connection.
MailProxy session component: Hold Ingress and Egress socket from MailProxy service. It is created by MailProxy service:
Create mail protocol base on service; and
Handling connection drop-down event on client/server side.

POP3 Component:

Implement function of POP3 protocol.

SMTP Component:

Implement function of SMTP protocol.

IMAPcomponent:

Implement function of NAP protocol.

Health Check Service Component:

Dummy service response health check request from HA Proxy.

MailFilter component:

MailFilter instance. MailProxy and MailFilter communicate via socket and mail filter. In some embodiments, MailFilter may be integrated as an plugin of MailProxy.

Mail Proxy Classes:

Mail Proxy also has a plurality of classes associated with it. The classes of the Mail Proxy are described below.

MailProxyServer Class:

Inheriting from Poco::Util::ServerApplication, it has all features and functions of application server. MailProxyServer is created as singleton instance, initialize, load plugin and create many MailProsyService and only one HealtchCheckService for HA Proxy.

BasicService Class:

Abstract class presents a service of MailProxy. If you want to developing new service for MailProxy, new service must inherit this class and override these method:

### Method:

BasicService::set/getOption( )—These method are used to pass option from configure to service
BasicService::getName( )—Get name of service. The name of service is determinate at created time

### Callback Method:

BasicService::initialize( )—This method is called after create derived service class
BasicService::start(void*arg=NULL)—This method is called after method initialize( ). Business rule and main function should be implemented in this method
arg: Optional argument pass though start( ) method
BasicService::pause( )—This method is called if MailProxy is paused from user or environment
BasicService::stop( )—This method is called if MailProxy Server stop this service immediately
BasicService::uninitialize( )—This method is called before this service will be destroyed

### Event Trigger:

Start—This event is raised to event handler when it started successfully
Stop—This event is raised to event handler when it stopped successfully
Pause—This event is raised to event handler when it paused successfully
Initialize—This event is raise to event handler when it initialize without any errors
UnInitialize—This event is raise to event handler when it de-initialize resource without error

HealthCheckService class:

Accepting connection checking from HA Proxy. This service only uses to response HA Proxy that MailProxy still alive.

### Method:

HealthCheckService::get/setIp( )—These method used to set or get IP Address (v4) which this service listens on.
HealthCheckService::get/setPort( )—These method used to set or get Port which this service combine with IP address
HealthCheckService::set/getThreadPoolSize( )—These method used to set or get number or thread which used to accept connection from HA Proxy

### Event Handler:

onInitializeIngress( )—This method is called from IngressService from event Initialize of it
onUninitializeIngress( )—This method is called from IngressService from event Unnitialize of it
onAccept( )—This method is called from IngressService inside when it accept the connection from HA Proxy
onAcceptFail( )—This method is called if IngressService inside cannot accept more connection from HA Proxy

### AbstractSocket Class:

Basic abstract socket layout for TCL, SSL socket or other type

### Method:

AbstractSocket::write( . . . )—This method is used to write data on this. After writing data successfully, event Write is raise to event listener
AbstractSocket::writeSync( . . . )—Similar to AbstractSocket::write( ) but uses synchronous mode instead of asynchronous mode
AbstractSocket::read( . . . )—This method is used to read data from socket/file descriptor. After reading data, event Read is raise to event listener
AbstractSocket::close( )—This method is used to shutdown and close connection. Event Shutdown is raised to event listener

### Event Trigger:

Read—This event is raised after reading data successfully
Write—This event is raised after writing data successfully
Shutdown—This event is raised if the connection is close

### Completed Asynchronous Callback Method:

AbstractSocket::handleRead( . . . )—Called from i/o socket of Boost::Asio on read method. This method also raise event Read or Shutdown
AbstractSocket::handleWrite( . . . )—Called from i/o socket of Boost::Asio on write method. This method also raise event Write or Shutdown

TCPSocket Class:

Inheriting from AbstractSocket, TCPSocket plays as native socket for asynchronous read/write/close on socket

SSLSocket Class:

Establishing encrypted SSL socket tunnel

IngressService Class:

Listening and accepting connection from mail client side

### Method:

IngressService::get/setIp( )—This method is used to set or get IP Address (v4) which listen on
IngressService::get/setPort( )—This method is used to set or get port to listen on
Ingress::accept( )—Virtual method accept connection when start( ) method of this service is called

### Event Trigger:

Accept—This event is raised after accept connection from mail c lent side
CannotAccept—This even is raised if this service cannot accept connection

### Completed Asynchronous Callback Method:

IngressService::handleAccept( . . . )—Called after accepting connection. If there is no error, it raises event Accept, otherwise raise event CannotAccept

IngressSSLService class:

Generic service for SSL from IngressService

### Method:

IngressSSLService::getPassword( )—Get password for ssl tunnel

### Event Trigger:

Handshake—This event is raise after handshake with mail client successfully
CannotHandshake—This event is raise if cannot handshake or ssl error

### Completed Asynchronous Callback Method:

IngressSSLService::handleAccept( . . . )—Called after accept connection. If there is no error, it raise event Accept, otherwise raise event CannotAccept
IngressSSLService::handleHandshake( . . . )—Called after handshake, if the result is successfully, raises event Handshake, otherwise raises event CannotHandshake

EgressService Class:

Connection to real mail server via method start

### Method:

EgressService::get/setTargetIp( )—This method is used to set or get IP Address (v4) which connect to
EgressService::get/setTargetPort( )—This method is used to set port to connect real server
EgressService::connect( )—Virtual method connect to real server when start( ) method is called

### Event Trigger:

Connect—This event is raised after connecting to real service successfully
CannotConnect—this event is raised when this service cannot connect to mail server

### Completed Asynchronous Callback Method:

EgressService::handleConnect( . . . )—This method is called after connecting to real server. If success, it raises event Connect, otherwise is CannotConnect

EgressSSLService class:

Generic egress service for SSL tunnel

### Event Trigger

Handshake—This event is raise after handshake with mail server successfully
CannotHandshake—This event is raise if cannot handshake or ssl error

### Completed Asynchronous Callback Method:

EgressSSLService::handleConnect( . . . )—Called after connecting to real server. If there is no error, it raise event Connect, otherwise raise event CannotConnect
EgressSSLService::handleHandshake( . . . )—Called after handshake, if the result is successfully, raises event Hands hake, otherwise raises event CannotHandshake

MailProxyService Class:

Main service of mail proxy. MailProxyServer creates many service base on configure file. This service also creates multi ingress/ingresSSLService and multi egress/egressSSL service for acception and connection request

### Method:

MailProxyService::set/getIp( )—Set or get IP Address for listening and accepting connection
MailProxyService::set/getPort( )—Set or get Port for listening
MailProxyService::set/getTargetIp( )—Set or get real mail server to connect via IP Address
MailProxyService::set/getTargetPort( )—Set or get real mail server to connect via port
MailProxyService::set/getThreadPoolSize( )—Set or get thread pool size. Basically, if thread pool size is set to 10, MailProxyService creates 30 thread to work, with:
10 threads are only used to accept connection
10 threads are used to handle read, write data on client side
10 threads are used to handle read, write data on server side include connect action
MailProxyService::setPlugin( . . . )—Set plugin for mail service perform on after getting email from server
MailProxyService::initialize( )—Create io_service, acceptor, Ingress/SSLService
MailProxyService::start( )—Start all IngressService and begin accept connection concurrent, this method also invoke start( ) of IngressService class concurrently
MailProxyService::stop( )—Stop all IngressService and other task
MailProxyService::uninitialize ( )—Release and destroy all resource

### Event Handler:

MailProxyService::onAccept( )—After accepting connection this method is call
MailProxyService::onAcceptOk( )—After handshake with client successfully in SSL mode or after onAccept( ) method in TOP mode
MailProxyService::onAcceptFail( )—This method is called if fail in accepting connection or cannot handshake with client
MailProxyService::onConnect( )—Called after connection to mail server successfully
MailProxyService::onConnectOk( )—This method is call after handshaking successfully in SSL mode or after onConnect( ) method in TOP mode. After this method, MailProxySession class is created and begin transaction in asynchronous mode
MailProxyService::onConnectFail( )—This method is called if fail in acceptation connection or cannot handshake with server

MailProxySession Class:

Created in MailProxy::onConnectOk( ) method and running in asynchronous mode via method process( ). This holds double instance of AbstractSocket: One from client side and another from server side

### Method:

MailProxySession::getIngressSocket( )—Get ingress socket
MailProxySession::getEgressSocket( )—Get egress socket
MailProxySession::getService( )—Get reference of MailProxyService
MailProxySesison::process( . . . )—Run this session in asynchronous mode. This method is call after instance had create in MailProxyService::onConnectOk( ) method. In this method, Mail protocol(POP3/IMAP/SMTP) instance is created

### Event Handler:

MailProxySession::onShutdownServer( )—Called if server shutdown connection
MailProxySesison::onShutdownClient( )—Called if client shutdown connection

POP3 Class:

Implement full feature of POP3 protocol

IMAP Class:

Implement full feature of IMAP protocol

SMTP Class:

Implement full feature of SMTP protocol

MailProxy Workflow:

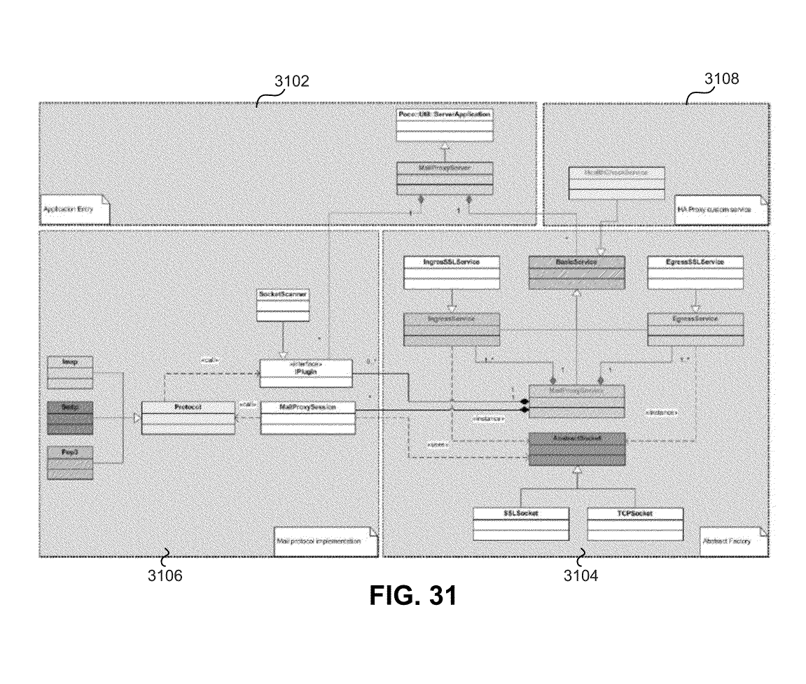

FIG. 31 is a workflow diagram for a MailProxy. MailProxy defines basic service to implement. An abstract factory pattern may be applied to create socket connection between mail client and mail server. Mail proxy has four components in abstraction: Application Entry 3102, Abstract Factory 3104, Mail protocol implement 3106, and HA Proxy custom service 3108. The Application Entry contains the MailProxyServer instance. This is main entry of program. The MailProxy Abstract Factory pattern to create a socket communication. The Mail protocol implement implements the mail session and protocol. The HA Proxy custom service is a dummy service that accepts health checks from the HA Proxy.

The classes and/or objects participating in the MailProxy pattern shown in FIG. 31 include a AbstractFactory (BasicService) that declares an interface for operations that create abstract socket. A ConcreteFactory (IngressService, IngressSSLService, EgressService, EgressSSLService) is also included that implements the operations to create concrete socket: TCPSocket/SSLSocket. The AbstractProduct (AbstractSocket) declares an abstract object for a type of abstract socket. The Product (TCPSocket, SSLSocket) defines a concrete socket to be created by the corresponding concrete factory, and implements the AbstractSocket class. The Client (MailProxyService) uses interfaces declared by AbstractFactory and AbstractProduct classes.

### Mail Filter:

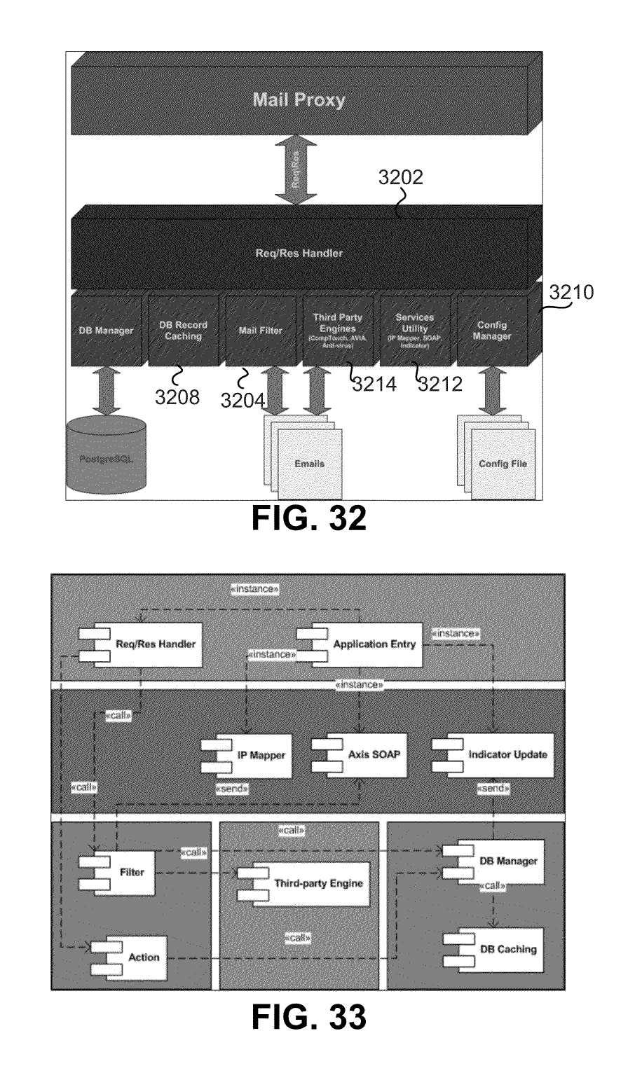

FIG. 32 is a block diagram of an exemplary architecture for a Mail Filter of a Mail Filter node. FIG. 33 is a schematic diagram illustrating various relationships between the components of the Mail Filter depicted in FIG. 32.

The Reg/Res Handler 3202 is the main component which listens for incoming requests over a configurable port, and then accepts the connections. The Handler itself maintains a pool of connection sockets where each connection represents a client connection when accepted will be allocated a socket inside this pool and it will be released when the client connection disconnected or destroyed. The Handler applies the Asynchronous Network programming using the epoll system call. The Handler controls a dispatcher which is a wrapper of epoll activities. Every connected socket client needs to be registered with this dispatcher and when a data stream available over this registered socket, Dispatcher will invoke its callback function to handle the data coming from the client.

The Mail Filter 3204 is the core functional component which executes the business logic applied on each of email filter/action request. All defined behaviors of every single filter or action are implemented by this component. The DB Manager 3206 is used to interact with the database access. The component is loose-coupling design, where it dynamically loads the database provider which has to implement a pre-defined interface. The DB Caching 3208 component is responsible for caching all query results so that the same query won't need to access the database again which could slow down the request processing. The caching data will be periodically refreshed based on its timeout value.

The Configuration Manager 3210 is responsible for loading all pre-configured parameters' values from a text file. The Service Utility 3212 comprises different services which provide the communication capability with remote applications as required by the application. The Service Utility may utilize dynamic libraries.

Third-party Engines 3214 may be included in order to support various filter activities such as, for example, image scanning, file scanning. The Mail Filter component communicates with these engines and passes these kinds of requests to them to process.

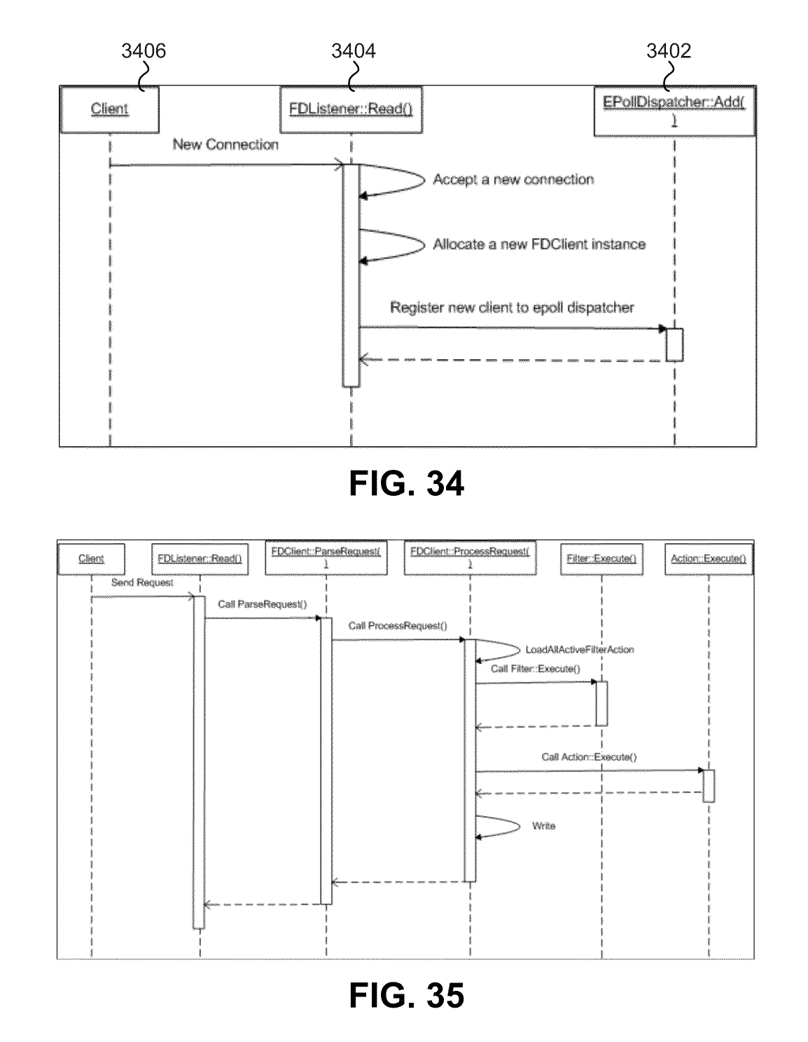

FIG. 34 is a sequence diagram illustrating a process for the Mail Filter to accept a new connection. As illustrated in FIG. 34, EPollDispatcher instance 3402 keeps polling events over its managed FDClient's sockets. When a new connection request coming, an event over the FDListener's 3404 socket is discovered by the dispatcher, and the dispatcher calls Read( ) method of registered FDListener instance to process the connection request. The FDListener instance 3404 maintains a pool of FDClient 3406 to use for allocating a new connection. Inside the Read( ) method, it starts to accept a new connection, and then allocates an FDClient instance for that connection, finally registers this FDClient to the dispatcher. Both FDListener and FDClient classes may be derived from the FDBase class, so to the dispatcher, it only manages the abstract FDBase type, so these instances is registered to dispatcher as a pointer. And this is transparent to the dispatcher on applying the behaviors on these FDs when events triggered on these FDs' sockets.

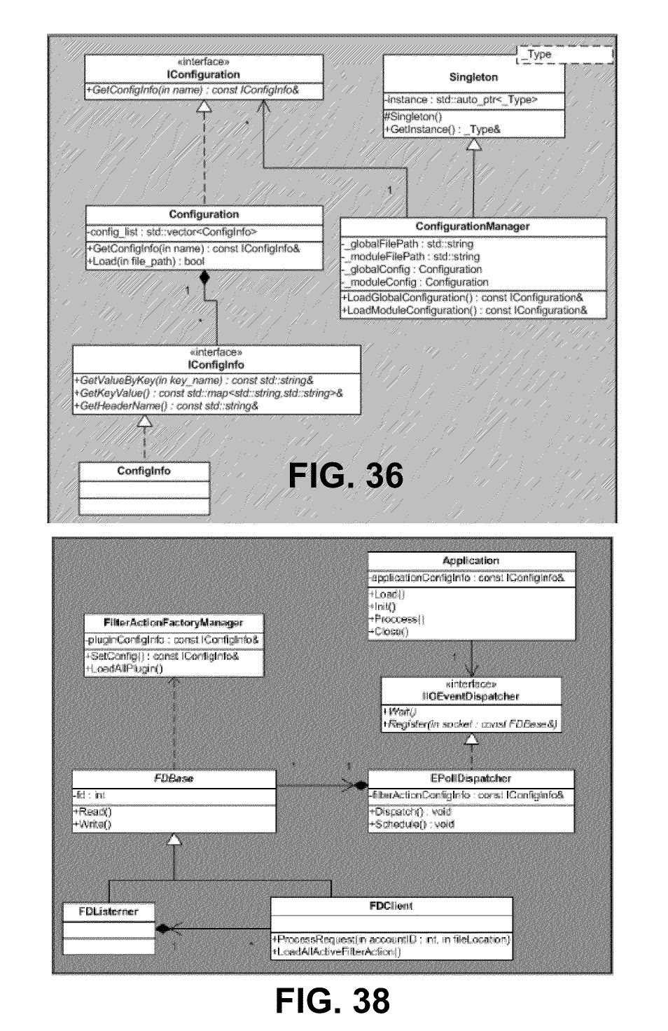

FIG. 35 is a sequence diagram illustrating how the Mail Filter handles a client request. Similar to handling a new connection, an event of incoming request over a registered FDClient socket is discovered through the dispatcher polling method. As shown in FIG. 35, corresponding Read( ) method of a FDClient is invoked to handle a client request. The main flow of processing will be loading all active filters and actions which are bound to this request's account from the database, executing every active filters, and then execute every active actions. Because it could be happened that many filters will have the same action, so inside each action, it maintains a collection of filters to make sure that it only processes on the firstly happened filter and ignores the remaining. Each action is also prioritized in the database, so the active actions are also ordered in its collection to make sure the right sequence of executing.

### Mail Filter Classes:

FIG. 36 is a class diagram of an exemplary Configuration Manager of the Mail Filter. The configuration file is in text format, where it contains different module's parameters. Each kind of module is separated by a header module name which is marked by the square bracket ([ ]), and each parameter is defined in a pair of key and value. The ConfigurationManager class applies the Singleton pattern, it manages the configuration usage. The Configuration class loads all modules configured parameters, each module's configuration info is presented by the data structure called ConfigInfo which is actually is a collection of (key, value) pair. ConfigurationManager Class manages the application's configured files, and manages the config.ini file. Using Singleton pattern, it can be used by different components to access the configuration file.

The core methods of the ConfigurationManager class include:

const IConfiguration& LoadGlobalConfiguration( )-->Load the global configured file by instantiate the Configuration class; and
const IConfiguration& LoadModuleConfiguration( )-->Load the module configured file by instantiate the Configuration class.

The Configuration class shown in FIG. 36, is responsible for loading a specified configuration file and then parsing its preset parameters. Its core methods include:

bool Load(const std::string& file_path=“ ”)-->This method parses the modules' configured parameters. Each module's parameter set is stored in the ConfigInfo structure where later on can be accessed by interested components; and
virtual const IConfigInfo& GetConfigInfo(const std::string& name) const throw(std::exception)-->third method returns a ConfigInfo structure, where the input argument will be the module header name.

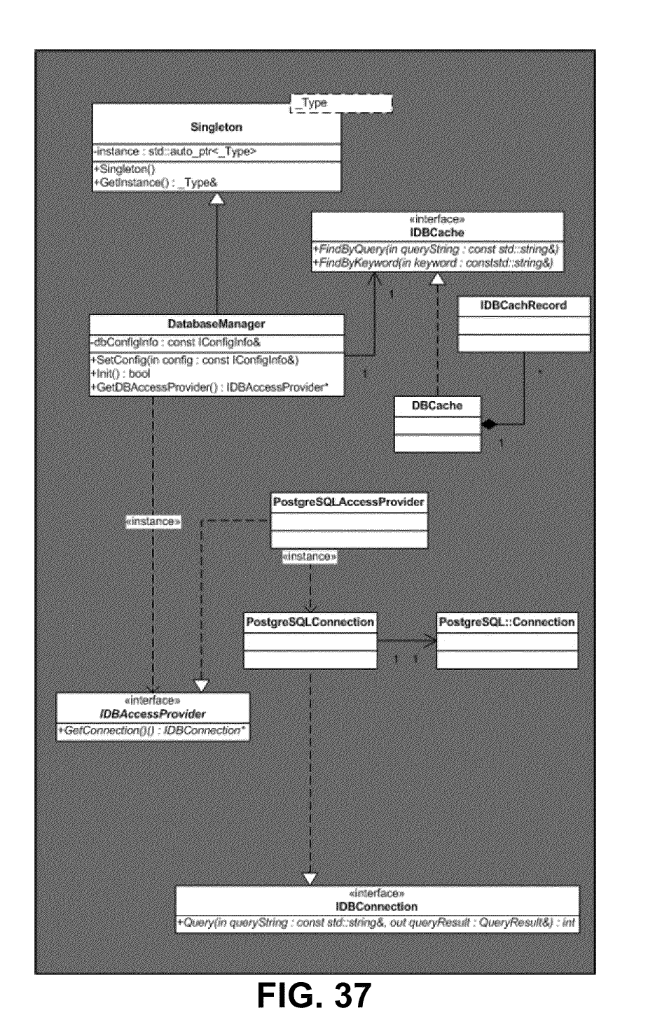

FIG. 37 is a class diagram of an exemplary DB Manager of the Mail Filter. The DBCacheRecord class shown in FIG. 37 represents a query string and a result set of its query string returned from database. Besides it contains some fields to help manage the record state such as: record life time, last access, last modification. In general, a record may be considered as a query string and its result set pair.

The DB Cache class manages all activities related to the cache manipulation. All records resulted from query string are stored in DBCache containers called query cache_cache_record_set. Besides it also maintains another multiset called keyword cache_keyword_search. _cache_record_set is only interested in the query result so only pair of query string and result set is stored, and keyword_search is also interested in the keyword (accountID) so that it duplicate a record which is the sample pair of query string but different keywords and this multiset is used to track the account access. That is the reason why a multiset containers is used here, where the same keys can be stored in the multiset. Further more, multiset helps to clean up all caching results related to an account that no longer exists. The DB Cache core methods include:

IDBCacheRecordPtr FindByQuery(std::string const& query)-->this method will look for if there is a record result in the cache corresponding to the input query string and return the record if existed;
std::list<IDBCacheRecordPtr> FindByKeyword(std::string const& keyword)-->this method will look for a list of records corresponding to this accountID, so it returns a list of records if existed; and
unsigned long DBCache:RemoveByKeword(_Predicate predicate, _PredicateKeyword predicate_keyword, _KeywordRemoveCallback callback)-->this method helps to remove records from the query cache or keyword cache depends on the input argument predicates.

The PostgreSQLAccessProvider class manages the PostgreSQL database connection. The PostgreSQLConnection class operates the query activities to the PostgreSQL database. It executes the query and returns the result set to the caller instance.

The DBManager class uses singleton pattern and manages the database provider through a provide interface called IDBAccessProvider. It is also the entry point to database access, query caching, and caching update. The DBManager core methods include:

IDBAccessProviderPtr GetDBAccessProvider( )-->returns the database access provider over the required interface, so application objects can use this provider without concerning about the specific providers such as MySQL, PostgreSQL; void UpdateCaching(UpdateIndicator const& param)-->Update the record cache, when receiving signal over the Unix name pipe; and
void UpdateAccount(int account_id);-->Update all cache records related to this account.

FIG. 38 is a class diagram of the Request/Response Handler. As shown in FIG. 38, the Application class of the Request/Response Handler is the application entry point class which initializes all necessary modules and libraries for the Request/Response Handler. The core methods of the Application class include:

void Init( ) ; Initializes all libraries and modules;
void Load( ) ; Loads all application configuration parameters for modules; and
void Process( ) ; Main program process where it runs the infinite loop.

The EPollDispatcher class manages the epoll( ) system call and dispatches the socket events to the right FD handlers so that the corresponding FD handlers can handle its own data stream over its socket. It is also a place to register a new socket fd and de-register a socket Id. The core methods of the EPollDispatcher class include:

virtual int Wait(const timeval* time); this method waiting for events happened over the registered sockets;
virtual void Add(FDBase* fdbase, int events=FD_EVENT_IN∥FD_EVENT_OUT, bool use_edge_trigger=false); this method allows open sockets to register its interested events with epoll, and when events occurred, its callback handler will be invoked;
virtual void Remove(FDBase* fdbase, bool close_socket=true); de-register events which has been registered before; and
virtual void Dispatch(int count); this method will invoke the callback handlers corresponding to the registered events of socket Id.

With reference to the FDBase, FDClient, and FDListener classes in FIG. 38, the socket FD is considered as an object where has its own behaviors. The template pattern is applied over here where the FDClient and FDListener derived from the FDBase. Both FDClient and FDListener implement the Read( ) method to their own behavior. To the Dispatcher class, it only knows the instance of FDBase, even the actual instances registered to it could be client or server, and when events triggered over these FD, it only invokes the Read( ) or Write( ) callback handler and doesn't care it is client or server. The FDListener is the server listener point, when every time an event over listener socket triggered, its Read( ) function is invoked. Basically it just accepts a new client socket connection, instantiates a new FD client and then registers it to the Dispatcher.

Each instance of FDClient class will handle a client request, its main method Read( ) will parse and then process the request including detect the accountID, load corresponding filters applied on this account's email and then load corresponding actions. The core method of the FDClient class include:

virtual int Read( ) ; reads stream buffer available on the socket;
void ParseRequest( ) ; Parse the read buffer to get the request; and
void ProcessRequest( ) ; the main flow to process further on the request including filters scanning and actions applying.

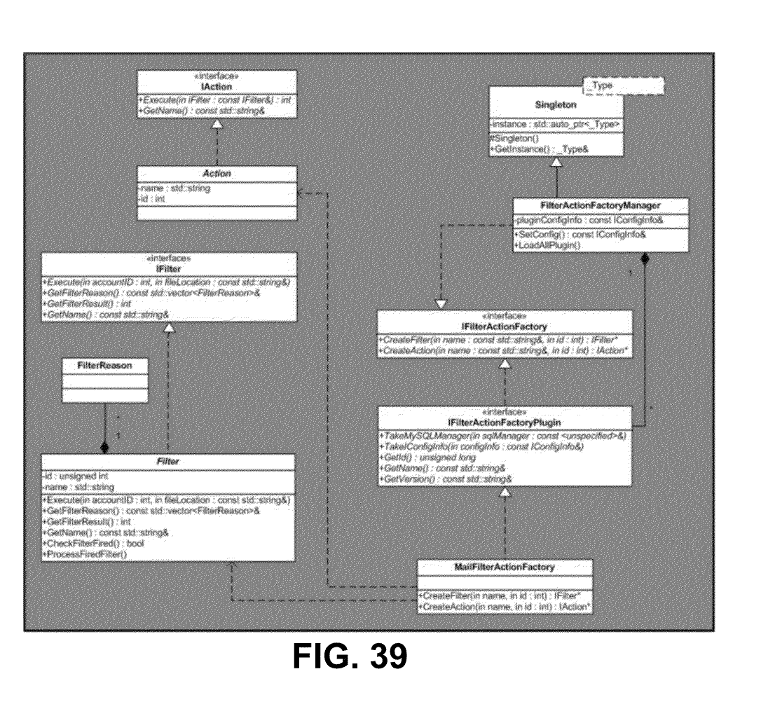

FIG. 39 is a class diagram of the Mail Filter class. The Mail Fiter module has been developed as a separated dynamic library that is intended to be loaded to the application initializing by the FilterActionFactoryManager class. This plug-in library design helps the application dynamically receive the new updates/fixes on any of filters or actions of the module.

The FilterActionFactoryManager class shown in FIG. 39 is responsible for loading the Mailfilter module which has been previously built as a dynamic library and initializing them library input facilities such as: library config, library third-party module. It may also manage the Mail Filter module to produce a new filter/action when requested, so it is also considered as a Filter/Action factory manager. The Core methods of the FilterActionFactoryManager class include:

void LoaddAllPlugin( ) ;-->This method loads the Mailfilter module, and all filters/actions name from the config file;
virtual IFilter* CreateFilter(const std::string& name, int id)-->This method will ask the CreateFilter( ) of MailFilterAction class to create a new filter per request; and
virtual IAction* CreateAction(const std::string& name, int id)-->This method will ask the CreateAction( ) of MailFilterAction class to create a new action per request.

The MailFilterAction class shown in FIG. 39 is considered a Filters/Actions factory and provides the function calls to instantiate filters/actions object per their names and id. Function calls are template functions where it initiates a new object based their provided class name and filter/action class name has been configured from the config file and then loaded by the FilterActionFactoryManager class. The core methods of the MailFilterAction class include:

virtual void TakeLogging(const ILogging& log); take the logger from the application, which then used by filters/actions object. This helps every module use a consistent logger;
virtual void TakeDBProvider(IDBAccessProvider& provider); take the database access provider, which then used by actions/filters object to get their own DB connection to execute their queries;
virtual void TakeConfigInfo(const IConfiginfo& config); take the config info for Mailfilter module;
virtual void TakeSoapAdapter(const ISoapAdapter& adapter); take the SOAP library in order to send the SOAP messages from filters/actions;
virtual IFilter* CreateFilter(const std::string& name, int id) const; Create a new filter instance based on its name; and
virtual IAction* CreateAction(const std::string& name, int id) const; Create a new action instance based on its name.

### Filter Classes:

The Filter class has been designed as template class, and two of its template methods are CheckFilterFired( ) and ProcessFiredFilter( ). So the common way of using the filter feature is just to call its Execute( ) method and get the return results without caring about its exact filter types. In order to apply the template pattern, all filter classes have to inherit the Filter class and implement its own behavior of template methods. Its core methods include:

virtual void Execute(int account_id, const std::string& file_path, int direction, void const* data=NULL) This method will execute the common behavior based on the template methods;
virtual bool CheckFilterFired( )=0; the template method to check whether the filter is fired (true); and
virtual void ProcessFiredFilter( )=0; the template method to process the filter if it is fired (true).

### Header Filter Group:

AccountFilter Class: The AccountFilter class' behavior applied to an email is a combination of RecipientFilter and SenderFilter class. Consequently, its implemented method CheckFilterFired( ) re-uses both classes behavior based on the input direction of the account. If the direction is outgoing, the RecipientFilter class is invoked and incoming, the SenderFilter( ) class is invoked.

AllFilter Class: The AllFilter class behavior is always true (fired) without reasons.

IncomingFilter Class: The IncomingFilter class is always true (fired) to mail's direction is incoming

OutgoingFilter Class: The OutgoingFilter class is a filter class and is always true (fired) to mail's direction is outgoing

RecipientFilter Class: The RecipientFilter class is a filter class interested in the “TO” field of an outgoing email (direction is outgoing). So it will be fired if one of email addresses in this field is not allowed. The not-allowed list will be retrieved from database query and every email address in the “TO” field will be checked against this list.

SenderFilter Class; The SenderFilter class is interested in the “FROM” field of an incoming email (direction is incoming). So the filter will be fired if the email address in this field is in not-allowed list. The not-allowed list will be retrieved from database query, and the email address in “FROM” field will be checked against this list.

### Body Filter Group:

AntiPhishingFilter Class: The AntiPhishingFilter class scans the whole email (header and body) to collect out the urls, and then check to see if any of these found urls are not allowed. The not-allowed list is retrieved Thorn the database query. The AntiPhishingFilter class core methods are:

virtual bool CheckFilterFired( ) ; Checking whether the filter is fired by scanning the email's body content to see if it has urls in the not-allowed list of urls; and
bool Processing(const mimetic::MimeEntity& entity, _Iter begin, _Iter end, int level=0);
Parsing the email into header and body, and then applying the regular expression search to see if it has any not-allowed urls. This method recursively parses the email if it is a multi-parts email.

AntiSpamFilter Class: The AntiSpamFilter class checks whether the email is a spam or not based on its rate score given by a third-party spam checking engine called CompTouch. The core methods of the AntiSpamFilter class include:

virtual bool CheckFilterFired( ) this method will forward the email to a third-party spam checking engine named CompTouch and waiting for its response score. If the email was a spam, its header will be added more info from the spam engine.

AntiVirusFilter Class: The AntiVirusFilter class is similar to the AntiSpamFilter and uses a third-party virus scanning engine to scan and send back the result.

AttachmentFilter Class: The AttachmentFilter class detaches all attachments in the email, and checks whether their file extensions are not allowed. The not-allowed list will be retrieved from database query. The core methods of AttachmentFilter class include:

bool CheckAttachment(mimetic::MimeEntity& entity, int level=0); this method recursively scans email's parts to get parts' attachments and check if their extensions are allowed or not.

ImageFilter Class: The ImageFilter class will recursively detach all attachment with ‘image’ file type and then saves these files in a directory and then pass the filepath to a third-party engine to scan the image content and receive back a score. This score will be compared to a Threshold value to decide whether the filter is fired.

KeywordFilter Class: The KeywordFilter class will bad all keywords from database query, and check if these exist inside the email content. In this filter, there is an exception to other filters that is it could apply replace/reject action right at this class.

LanguageFilter Class: The LanguageFilter class tries to filter out the not-allowed language based on the text content of the email's body. The language detection is done by another library called libtextcat. So the filter also parses the multi-part email into parts and using this library to detect the email part language and compare to the allowed list of languages retrieved from database query.

### Action Classes:

Action Class: Similar to the Filter class, the template pattern is also applied to the Action class where its template method is Run( ). So all derived actions class will have to implement the Run( ) method to their own behaviors. It is transparent to outside calls where they just need to call the action's Run( ) method, and don't care about the actual behavior

AddFooterAction Class: The AddFooterAction class is applied on outgoing email. Every end of email's parts will be added this footer. The footer is a combination of placeholder variables where they will be replaced by content retrieved from database query. The replace content type (text or html) will be corresponding to the part's content.

BotAction Class: The BotAction class is interested in SenderFilter and RecipientFilter, it will create an entry in BotSpooler table in corresponding a filter reason.

DiscardAction Class: The DiscardAction class is interested in the outgoing emails. The email will be discarded.

ForwardAction Class: The ForwardAction class creates entries on the ForwardSpooler table, the number of entries related to the Forward table and the account

LogAction Class: The LogAction class creates an entry in LogSpooler table, and every email address in TO and “FROM” field will have an entry in LogSpoolerEmail.

OriginalDialupHeaderAction Class: The OriginalDialupHeaderAction class adds an additional header of original provider into the email's header. The header will be loaded from the configuration file, and the original provider IP will be retrieved from the ipmapper library.

ReplaceAction Class: With the ReplaceAction class there are two types of actions applied on the email: the replace action for incoming mails and the reject action for outgoing mails. The replace action replaces complete email content with a prepared message retrieved from the database.

TagAction Class: The TagAction class tags a value right at beginning of the email's subject string. The tag value retrieved from the Tag table.

### IM Filter Node/Module:

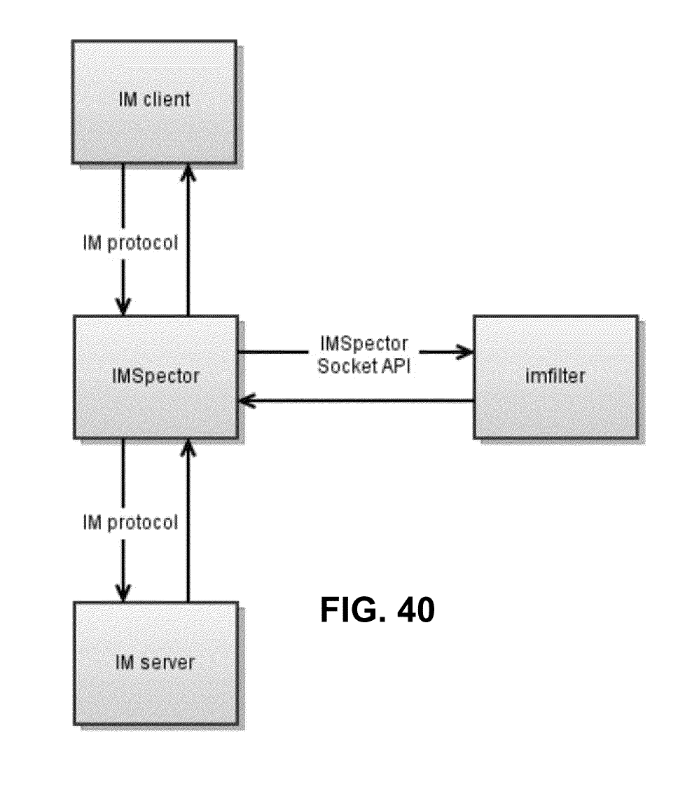

FIG. 40 is a block diagram of an exemplary architecture for an IM Filter. As shown in FIG. 40, Imfilter 4002 is a filtering service for IMSpector 4004. Imfilter 4002 interacts with the IMSpector 4004 through an IMSpector Socket API. More specifically, Imfilter 4002 acts as filter plugin for IMSpector 4004. IMSpector 4004 is a proxy for different Instant Message (IM) networks. When IMSpector receives message, it connects to the filter plugin via a unix socket send message, waits for answer, and then closes the connection. Thus, there is at least one message per connection.

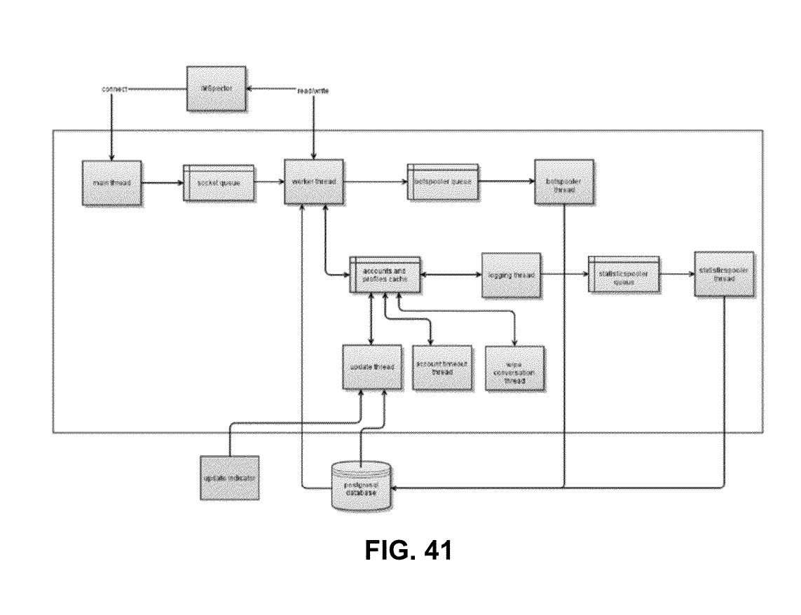

FIG. 41 is a flowchart of IM Filter process threads. As shown in FIG. 41, Main(main.c:main( )) function is responsible for initialization, wafting for a new connection from IMSpector, and putting a new socket in the socket_queue. Also, in some embodiments, all threads may be started in main( ) function after fork.

FIG. 41 also shows the Worker thread(main.c:message_worker_thread( )). The Worker thread reads message from socket, parses the message. The Worker thread then performs a look up for a corresponding account in account_id_index, then loads account data from database and applies it to the filters, and then writes the result to the socket.

The Statisticspooler thread(statistics.c:statisticspooler_insert_thread( )) and Botspooler thread(botspooler.c:botspooler_insert_thread( )) shown in FIG. 41 are used to speed up database operations. botspooler/statistics data does not need to be stored immediately but database operation due to network IO can take time. As a result, in such embodiment rather than direct insertation to the database, necessary data may be stored in memory(statisticspooler_queue and botspooler_queue), and then inserted into the database in a separate thread.

With continuing reference to FIG. 41, the Update thread(update.c:update_thread( )) updates the indicator client. The Wipe conversation(main.c:wipe_conversations_thread( )) frees old conversations. The Account timeout thread(main.c:account_timeout_thread( )) frees inactive accounts. The Logging thread(statistics.c:logging_thread( )) schedules the dumping of statistics for accounts.

### IM Filters (Components):

In general, all IM filters may follow the following Filter function prototype: void filter_function(struct im_message *message). IM filter may also change message->response field to RESP_BLCK, RESP_ERR or RESP_MDFY. In such an embodiment, the message->response is RESP_BLCK or RESP_ERR, no further filters are applied.

Service Filter:

The Service filter checks whether IM service is allowed for the account. In most embodiments, there may be no difference in the treatment of incoming or outgoing messages.

Account Filter:

The Account filter checks for every message if the protocol (line two of the message) in conjunction with the localid (line five of the message) and the help of the table “User” which is stored in memory is allowed for chatting or not. In order to check this the protocol value from line two of the message is translated into a “ServiceId” and also the value of the localid from line five of the message is extracted and it is checked if an entry exists for the “ProfileId” where “Username” matches localid value, “ServiceId” matches “ServiceId” and the record has the “UserStatusId” 1. If the account is not allowed for chatting the response from this application is block—otherwise pass.

Chatpartner/Bot-Incoming/Bot-Outgoing Filter:

The Chatpartner/Bot-incoming/Bot-outgoing filter checks for every message if the protocol (line two of the message) in conjunction with the remoteid (line six of the message) and the help of the table “User” which is stored in memory is allowed as chat partner or not. In order to check this the protocol value from line two of the message is translated into a “ServiceId” and also the value of the remoteid from line six of the message is extracted and it is checked if an entry exists for the “ProfileId” where “UserName” matches remoteid value, “ServiceId” matches “ServiceId” and the “UserStatusID” of the record is retrieved. If the “UserStatusId” is 2 and no other filter is configured than this application returns “PASS” through the socket. If the “UserStatusId” is 3 or 4 the answer of this application is block.

If no record can be found in “User” it shall be checked if BOT-INCOMING or BOT-OUTGOING is enabled. If line one of the message is imspector-incoming and BOT-INCOMING is enabled or the first line of the message is imspector-outgoing and BOT-OUTGOING is enabled or both are enabled than the following has to be done: An insert has to be made to “BotSpooler” with localid value as “LocalUserName”, remoteid value as“RemoteUserName” and protocol from line two of the message shall be translated into a “ServiceId” and be used as “ServiceId”. Of course an entry into the table shall only be made if it not already exists with these values (“LocalUserName”, “RemoteUserName”, “ServicId”, “DirectionId”) for this “ProfileId”. The “DirectionId” depends on the direction from line one. The BOT-INCOMING/BOT-OUTGOING component only makes sense if ACCOUNT-FILTER is enabled so that no separate decision regarding the message (block or pass) has to be made.

Keyword Filter:

The Keyword filter looks for defined keyword in message. There are two types of keywords: profile specific and common keywords. Common keywords divided in groups. Each keyword can block message or can be replaced with asterisks. This depends on “ActionId” field in “ProfileValue” and “ActiveGroup” tables. If keyword is replaced the keyword in question within the user-generated text is replaced with one to three stars “*”. One if the keyword has only one character, two if the keyword has only two characters and three if the keyword has three or more characters. Since the response has to be the same size when answering through the socket the user-generated text has to be filled up with white-spaces at the end to make up for the difference of the length of the keyword and the three stars. If “ReportId” field in “ProfileValue” and “ActiveGroup” tables is not 1(NONE), whole conversation where the keyword was found will be sent via soap call.

Language Filter:

The Language filter checks whether the language of the message is allowed for the account. The allowed languages can be determined from the table “Language.AllowedLanguage”. Libtextcat may be used to detect message language.

Logging Filter:

The Logging filter counts number of passed/blocked messages. In some embodiments, the Logging filter may never block messages. If LOGGING is enabled, a background service shall run for this “AccountId” every 60 Minutes (a value coming out of the configuration file) and put statistics in “StatisticSpooler”. “DatelineStart” shall be the date and time of the last run and “DatelineEnd” the current date and time. “LocalUserName” is the localid value, “RemoteUserName” the remoteid value. “ServiceId” is the translated protocol used. For the values “MessagesIn” and “MessagesOut” only the messages between the last and the current run are regarded (date and time).

### Blocking Skype Messages:

Embodiments of the system 100 may be implemented to block video conferencing services such as Skype. Skype typically uses SSL port (443) when destination ports >1024 (unprivileged ports) are blocked. Skype is binding to port 80 if it is set in the options and Skype is running with admin privileges on Windows, which should not be possible on Mac, Iphone and Linux by default. Skype also does not send a request for fetching the newest version of Skype available on their servers if it is unset in its options.

As a general rule, UDP and TCP traffic may be treated independently. A first step in finding Skype machines is to do a start on the beginning of a Skype start. During a Skype start, Skype tries to login and asks for the newest available version of Skype on the Skype server (HTTP server on port 80). Because of this, the system 100 may be able to compare the request against the string “GET http://ui.skype.com” and, optionally, with the URL content “getnewestversion”: After this procedure, Skype connects to the Skype master node on port 33033 and the system can look for any TCP request on this port and block this IP. Then the system 100 catches every TOP packet and looks to see if the payload content starts with 0x160301 or 0x170301. On the UDP side, the system may look for a signature pattern where the UDP payload contents third byte is 0x02 and block all these IPs.

As a further filter, the system can collect IPs into a list and perform a WHOIS request for any UDP/TCP requests destination address. The results of the WHOIS requests may then be used to determine whether the destination can be classified as a good or bad host (and added to a good hosts list or a bad hosts list). As an option, WHOIS responses containing the string “SKYPE” can be put into the bad host list as a default. Subsequently IPs from the bad host list may be blocked by the system 100.

### Antivirus Module:

Embodiments of the system 100 may be implemented with an antivirus module to check communications for virsues and other malware and then block or quarenteen such communications. As previously mentioned, an embodiment of the system may be implemented with an AVIA server. The AVIA server may be used for a variety of tasks including virus checking, image analysis, movie analysis, and image virus checking. In one embodiment, the AVIA server listens on localhost port 51500 in order to receive requests. The AVIA server may then send results through TCP/IP. Once a communication has arrived to the AVIA server, a temporary file may be created with the content of the request that can be passed to the antivirus/malware detection/removal application via a function call.

In view of the foregoing description, various embodiments of a secure network gateway system and filtering method of using the system may be implemented. In such embodiment, a network interface may be provided that is capable of connecting to a wide area network such as the Internet. The system may also include a tunneling front end node that is capable of establishing a communication tunnel with a remote client access point so that all communications between the remote access client and the wide area network are transmitted via the tunneling front end node. In one embodiment, the communication tunnel between the tunneling end and client access point may be an OpenVPN tunnel, a Point-to-Point Tunneling Protocol (PPTP) tunnel; or a Locator/Identifier Separation Protocol (LISP) tunnel. Packets transmitted through the communication tunnel may be encapsulated. The tunneling front end may include a LISP compatible router in LISP implementations of the system.

The client access point may comprise a communication device that is capable of establishing a communication link with one or more user devices. User devices may include computers, mobile devices, and smart phone, for example.

The tunneling front end may also be capable of authenticating a user of a user device that is in communication with the client access point whereby the user is afforded or allowed to access to the wide area network through the communication tunnel after a successful authentication. The system may maintain a set of filtering rules associated with the authenticated user that define how transmissions between the user and wide area are to be handled. Based on the filtering rules, the tunneling front end may determine how to handle transmissions to and from the authenticated user. In operation, the tunneling front end may pass at least some of the transmissions received from the user to at least one of the filter nodes according to the filtering rules.

After the user has been successfully authenticated, a tunneling identifier associated with the user may be included in subsequent communications between the user device and the tunneling front end node.

Authentication of the user may be accomplished as follows. The user of the user device may have previously registered with the secure network gateway system and has credentials associated with the system (and that are stored in the system) The tunneling front end may be capable of using these user credentials to determine whether authentication information received from the user of the user device matches the credentials of the registered user. If so, the user is then authenticated as the registered user or at least a user approved by the registered user (such as e.g., a family member of the registered user).

In some embodiments, the client access point may comprise a modem and a router. Further, the client access point may include a tunneling component capable of forming the communication tunnel with the tunneling front end node. The tunneling component may be located within the client access point. Alternatively, the tunneling component may be coupled to the client access point. In one embodiment, the tunneling component may be implemented in LISPmob.

The system may also include a plurality of filter nodes that in communication with the network interface so that the filter nodes may be connected to the wide area network via the network interface.

The filter nodes may be capable of sending transmissions of the authenticated user passed from the tunneling front end to the wide area according to the filtering rules associated with the authenticated user. The filter nodes may also be capable of receiving transmissions from the wide area network destined to the authenticated user. In either case, the filter nodes may filtering the transmissions received from the wide area network according to the filtering rules associated with the authenticated user and passing the filtered transmissions to the tunneling front end for forwarding the filtered transmissions to the authenticated user via the communications tunnel.

The filtering rules include at least one of: one or more rules for blocking certain transmissions between the authenticated user and wide area network, one or more rules for allowing certain transmissions between the authenticated user and the wide area network, and one or more rules for filtering content of transmissions received from the wide area network that are intended for the authenticated user.

The filtering rules may be based on the age of the authenticated user. For example, an adult user may have greater access to the Internet (i.e., less filtering or restrictions to Internet sites and content) than a child user, with the filtering rules for child users being more restrictive or limiting than those for adults so that Internet sites and content accessible to a child user is more restricted. In addition, the filtering rules of child user may be set or defined by a parent or guardian of the child so that the filtering is customized for the child according to the desires of the parent or guardian.

Embodiments of the system may also include a worker node that is capable of receiving one or more status messages from the other nodes of the system. These messages may contain information concerning activity or status of the one or more nodes. In response to these received status messages, the worker node may generating one or more jobs for the nodes. The worker node may then send each generated job to a job dispatcher or manager node.

The job dispatcher node may receive the generated job(s) and then assign and dispatch the generated job(s) to the appropriate node(s) by sending messages to the nodes instructing them to perform the assigned jobs.

The job dispatcher may also capable of scheduling jobs based on the type of job and the location of the target node. The jobs include parallel-type jobs and sequential-type jobs. In such an embodiment, the job dispatching node may send a message for a pending parallel-type job to the assigned node as soon as the assigned node indicates no other job with a status of processing is currently assigned to that node. On the other hand, the job dispatching node may send a message for a pending sequential-type job to the assigned node when the assigned node has only one job with a status of processing and that other job must be completed before the message for the pending sequential-type job can be sent.

In one embodiment, the messages relating to the functionality of the worker node and job dispatcher may be SOAP messages.

The system may also be provided with an internal communications network or bus coupling the nodes together through which the nodes are capable of sending communications (e.g., packets, messages, information, and data) between the various components of the secure network gateway system.

The filter nodes may include one or more web filter nodes that are capable of receiving at least HTTP packets as well as one or more mail filter nodes that are capable of receiving at least packets conforming to at least one electronic mail message format (e.g., SMTP and POP, etc.), and one or more instant message filters capable of receiving instant messaging formatted packets.

In one embodiment, the web filters may be capable of sending and receiving HTTP traffic to and from the user via the tunneling front end node/HAProxy. The web filters may also be capable of filtering HTTP traffic between the user and the Internet according to filtering criteria associated with the registered user so that the web filters can blocking or allow HTTP traffic between the registered user and the Internet based on the filtering criteria. Both the content of outgoing and incoming HTTP requests may be filtered. In addition, the HTTP packets may be filtered based on URLs contained in the requests.

The mail filters may be capable of sending and receiving mail packets to and from the user via the tunneling front end node/HAProxy. The mail filters may also filter electronic mail traffic between the user and the Internet according to filtering criteria associated with the registered user and thereby blocking or allowing electronic mail to and from the user.

The messaging filters may be capable of allowing or blocking instant message traffic between the registered user and the Internet based on the filtering criteria. The filtering criteria for messaging filters may include for example criteria for blocking objectionable (i.e., bad) words in the content of the message traffic.

The filter nodes may also include one or more a game filter nodes capable of filtering game content. As another option, the filter nodes may include at least one a file/media filter node capable of filtering at least one of content, streaming content, downloadable content, image content, and video content. A storage node may be provided in the system that is capable of temporarily storing data downloaded from the wide area network (Internet). A scanning element may be associated with the storage node that is capable of scanning the downloaded data according to the filtering rules associated with the authenticated user to identify portions of the data that are to be blocked from delivery to the user.

The filtering rules may include one or more filtering rules or criteria that have been selected by a registered user. For example, a parent or guardian can set filtering rules for a child so that the filtering rules may be used by the filter nodes to filter packets, data, information, and content to and from the Internet sent by or destined to the authenticated user.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., The article of manufacture containing the computer code may be made and/or used by executing the code directly from one medium, by copying the code from one medium to another medium, or by transmitting the code over a network.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A system, comprising:
a network interface capable of connecting to a wide area network;
a tunneling front end node capable of establishing a communication tunnel with a client access point, wherein packets transmitted through the communication tunnel are encapsulated, the tunneling front end node being capable of authenticating a user of a user device in communication with the client access point whereby the user is allowed access to the wide area network after a successful authentication through the communication tunnel;
a plurality of filter nodes in communication with the network interface such that the filter nodes are connected to the wide area network via the network interface;
a plurality of filtering rules associated with the authenticated user defining how transmissions between the user of the user device and wide area network are to be handled, the tunneling front end node being capable of determining how to handle transmissions to and from the authenticated user according to the filtering rules, wherein the tunneling front end node passes at least some of the transmission received from the authenticated user to at least one of the filter nodes according to the filtering rules;
the filter nodes being capable of sending transmissions of the authenticated user passed from the tunneling front end node to the wide area network according to the filtering rules, the filter nodes being capable of receiving transmissions from the wide area network destined to the authenticated user, and the filter nodes being capable of filtering the transmissions received from the wide area network according to the filtering rules and passing the transmissions to the tunneling front end node for forwarding the transmissions to the authenticated user via the communications tunnel;
a worker node capable of receiving one or more messages from one or more of nodes, the messages containing information concerning the status of the one or more nodes, the worker node being capable of generating one or more jobs in response to a received message and sending each generated job to a job dispatcher node; and
the job dispatcher node being capable of receiving the generated jobs sent by the worker node, the job dispatcher node being capable of assigning at least one of the generated jobs to one of the nodes and sending messages to that node to perform the assigned job.

2. The system of claim 1, wherein the communication tunnel between the tunneling end node and client access point comprises at least one of a OpenVPN tunnel, a PPTP tunnel, and a LISP tunnel.

3. The system of claim 1, wherein the filtering rules include at least one of: one or more rules for blocking certain transmissions between the authenticated user and wide area network, one or more rules for allowing certain transmissions between the authenticated user and the wide area network, and one or more rules for filtering content of transmissions received from the wide area network that are intended for the authenticated user.

4. The system of claim 1, wherein the job dispatcher is capable of scheduling jobs based on the type of job and the location of the target node.

5. The system of claim 1, wherein the jobs include parallel-type jobs and sequential-type jobs.

6. The system of claim 5, wherein the job dispatching node is capable of sending the message for a pending parallel-type job to the assigned node as soon as the assigned node indicates no other job with a status of processing is currently assigned to that node.

7. The system of claim 5, wherein the job dispatching node is capable of sending the message for a pending sequential-type job to the assigned node when the assigned node has only one job with a status of processing.

8. The system of claim 1, wherein a tunneling identifier associated with the user is included in subsequent communications between the user device and the tunneling front end node after the user has been successfully authenticated.

9. The system of claim 1, further comprising an internal communications network through which the nodes are capable of sending communications between one another.

10. The system of claim 1, wherein the filter nodes including one or more web filters capable of receiving at least HTTP packets.

11. The system of claim 1, wherein the filter nodes include one or more web filter nodes capable of receiving at least HTTP packets, one or more mail filter nodes capable of receiving packets conforming to at least one electronic mail message format, and one or more instant message filters capable of receiving instant messaging format packets.

12. The system of claim 11, wherein the filter nodes include one or more a game filter nodes capable of filtering game content.

13. The system of claim 11, wherein the filter nodes include at least one a file/media filter node capable of filtering at least one of content, streaming content, downloadable content, image content, and video content.

14. The system of claim 1, further including a storage node capable of temporarily storing data downloaded from the wide area network, the storage node having a scanning element capable of scanning the downloaded data according to the filtering rules to identify portions of the data that are to be blocked from delivery to the authenticated user.

15. The system of claim 1, wherein the filtering rules have at least one filtering rule selected by a registered user.

16. The secure network gateway system of claim 1, wherein the messages sent by the worker node and the job dispatcher node comprise SOAP messages.

17. The system of claim 1, further comprising a firewall node capable of maintaining the filtering rules associated with authenticated user in an IP table.

18. The system of claim 17, wherein the IP table is created after the user has been authenticated.

19. The system of claim 18, wherein the IP table is torn down after the user has logged out.

20. The system of claim 1, wherein after a predetermined amount of time has elapsed after authentication, the user is automatically logged out.

21. The system of claim 1, wherein after a predetermined amount of time of inactivity by the authenticated user has elapsed, the user is automatically logged out.

22. A method for filtering communications, comprising:
establishing a communication tunnel between a tunneling front end node and a client access point, wherein packets transmitted through the communication tunnel are encapsulated;
authenticating a user of a user device in communication with the client access point whereby the user is allowed to access to the wide area network after a successful authentication through the communication tunnel;
determining how to handle transmissions to and from the authenticated user according to a plurality of filtering rules associated with the authenticated user;
passing at least some of the transmission received by the tunneling front end node from the user of the user device to at least one of a plurality of filter nodes according to the filtering rules;
the filter nodes sending transmissions of the authenticated user to the wide area network according to the filtering rules associated with the authenticated user;
the filter nodes receiving transmissions from the wide area network destined to the authenticated user;
the filter nodes filtering the transmissions received from the wide area network according to the filtering rules associated with the authenticated user; and
forwarding the transmissions to the authenticated user via the communications tunnel.

23. The method of claim 22, further comprising receiving at a worker node one or more messages from one or more of nodes, wherein the messages contain information concerning activity or status of the one or more nodes, the worker node generating one or more jobs in response to a received message and sending each generated job to a job dispatcher node.

24. The method of claim 23, further comprising receiving at the job dispatcher node the generated jobs sent by the worker node, assigning the generated job to one of the nodes, and sending a message to the node instructing it to perform the assigned jobs.

25. The method of claim 24, wherein the jobs include parallel-type jobs and sequential-type jobs.

26. The method of claim 25, wherein the job dispatching sends the message for a pending parallel-type job to the assigned node as soon as the assigned node indicates no other job with a status of processing is currently assigned to that node.

27. The method of claim 25, wherein the job dispatching node sends the message for a pending sequential-type job to the assigned node when the assigned node has only one job with a status of processing.

28. The method of claim 24, wherein the messages comprise SOAP messages.

29. The method of claim 22, wherein the filter nodes include one or more web filter nodes receiving at least HTTP packets; one or more mail filter nodes receiving at least packets conforming to at least one electronic mail message format; and one or more instant message filters receiving at instant messaging format packets.

30. The method of claim 22, wherein the communication tunnel between the tunneling end node and client access point comprises at least one of a OpenVPN tunnel, a PPTP tunnel, and a LISP tunnel.
